(19) United States
(12) Patent Application Publication
(10) Pub. No.: US 2026/0271127 A1
(43) Pub. Date: Sep. 10, 2026

(54) DISCONTINUOUS RECEPTION AND UE COLLABORATION

(71) Applicant: QUALCOMM Incorporated, San Diego, CA (US)

(72) Inventors: Cihat KECECI, Flemington, NJ (US); Navid ABEDINI, Basking Ridge, NJ (US); Tommy AZZINO, Jersey City, NJ (US); Jianghong LUO, Skillman, NJ (US); Aleksandar DAMNJANOVIC, Del Mar, CA (US)

(21) Appl. No.: 19/075,610

(22) Filed: Mar. 10, 2025

(51) Int. Cl. H04W 76/28; H04W 52/02; H04W 72/1263

(52) U.S. Cl. CPC H04W 76/28; H04W 52/0235; H04W 72/1263

(57) ABSTRACT

A UE receives multiple discontinuous reception (DRX) configurations, wherein the multiple DRX configurations include: more than two DRX configurations for the UE as an individual UE, or at least a first DRX configuration for the individual UE and at least a second DRX configuration for a collaborative UE group. The UE monitors for control signaling based on the multiple DRX configurations. In some aspects, the UE receives multiple DRX configurations; and receives a wake up signal (WUS) that indicates a cause for the UE to wake up, where the cause is associated with a DRX configuration of the multiple DRX configurations.

### INTRODUCTION

The present disclosure relates generally to communication systems, and more particularly, to wireless communication that includes discontinuous reception (DRX).

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. Some aspects of later wireless communication, such as 6G or others, may be based on aspects of 5G NR and/or 4G LTE. There exists a need for further improvements, in 5G NR and additional wireless communication technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method of wireless communication at a user equipment (UE) is provided. The method includes receiving multiple discontinuous reception (DRX) configurations, wherein the multiple DRX configurations include: more than two DRX configurations for the UE as an individual UE, or at least a first DRX configuration for the individual UE and at least a second DRX configuration for a collaborative UE group; and monitoring for control signaling based on the multiple DRX configurations.

In an aspect of the disclosure, an apparatus for wireless communication at a UE is provided. The apparatus includes means for receiving multiple DRX configurations, wherein the multiple DRX configurations include: more than two DRX configurations for the UE as an individual UE, or at least a first DRX configuration for the individual UE and at least a second DRX configuration for a collaborative UE group; and means for monitoring for control signaling based on the multiple DRX configurations.

In an aspect of the disclosure, an apparatus for wireless communication at a UE is provided. The apparatus includes one or more memories, and one or more processors coupled to the one or more memories and configured to cause the UE to receive multiple DRX configurations, wherein the multiple DRX configurations include: more than two DRX configurations for the UE as an individual UE, or at least a first DRX configuration for the individual UE and at least a second DRX configuration for a collaborative UE group; and monitor for control signaling based on the multiple DRX configurations.

In an aspect of the disclosure, a computer-readable storage medium (e.g., a non-transitory computer-readable storage medium) storing computer executable code for wireless communication at a UE is provided. The code when executed by one or more processors causes the UE to: receive multiple DRX configurations, wherein the multiple DRX configurations include: more than two DRX configurations for the UE as an individual UE, or at least a first DRX configuration for the individual UE and at least a second DRX configuration for a collaborative UE group; and monitor for control signaling based on the multiple DRX configurations.

In an aspect of the disclosure, a method of wireless communication at a user equipment (UE) is provided. The method includes receiving multiple DRX configurations; and receiving a wake-up signal (WUS) that indicates a cause for the UE to wake-up, wherein the cause is associated with a DRX configuration of the multiple DRX configurations.

In an aspect of the disclosure, an apparatus for wireless communication at a UE is provided. The apparatus includes means for receiving multiple DRX configurations; and means for receiving a WUS that indicates a cause for the UE to wake-up, wherein the cause is associated with a DRX configuration of the multiple DRX configurations.

In an aspect of the disclosure, an apparatus for wireless communication at a UE is provided. The apparatus includes one or more memories, and one or more processors coupled to the one or more memories and configured to cause the UE to receive multiple DRX configurations; and receive a WUS that indicates a cause for the UE to wake-up, wherein the cause is associated with a DRX configuration of the multiple DRX configurations.

In an aspect of the disclosure, a computer-readable storage medium (e.g., a non-transitory computer-readable storage medium) storing computer executable code for wireless communication at a UE is provided. The code when executed by one or more processors causes the UE to: receive multiple DRX configurations; and receive a WUS that indicates a cause for the UE to wake-up, wherein the cause is associated with a DRX configuration of the multiple DRX configurations.

In an aspect of the disclosure, a method of wireless communication at a network node is provided. The method includes configuring multiple DRX configurations for a UE, wherein the multiple DRX configurations include: more than two DRX configurations for the UE as an individual UE, or at least a first DRX configuration for the UE as the individual UE and at least a second DRX configuration for a collaborative UE group; and providing control signaling for the UE based on the multiple DRX configurations.

In an aspect of the disclosure, an apparatus for wireless communication at a network node is provided. The apparatus includes means for configuring multiple DRX configurations for a UE, wherein the multiple DRX configurations include: more than two DRX configurations for the UE as an individual UE, or at least a first DRX configuration for the UE as the individual UE and at least a second DRX configuration for a collaborative UE group; and means for providing control signaling for the UE based on the multiple DRX configurations.

In an aspect of the disclosure, an apparatus for wireless communication at a network node is provided. The apparatus includes one or more memories, and one or more processors coupled to the one or more memories and configured to cause the network node to configure multiple DRX configurations for a UE, wherein the multiple DRX configurations include: more than two DRX configurations for the UE as an individual UE, or at least a first DRX configuration for the UE as the individual UE and at least a second DRX configuration for a collaborative UE group; and provide control signaling for the UE based on the multiple DRX configurations.

In an aspect of the disclosure, a computer-readable storage medium (e.g., a non-transitory computer-readable storage medium) storing computer executable code for wireless communication at a network node is provided. The code when executed by one or more processors causes the network node to: configure multiple DRX configurations for a UE, wherein the multiple DRX configurations include: more than two DRX configurations for the UE as an individual UE, or at least a first DRX configuration for the UE as the individual UE and at least a second DRX configuration for a collaborative UE group; and provide control signaling for the UE based on the multiple DRX configurations.

In an aspect of the disclosure, a method of wireless communication at a network node is provided. The method includes providing multiple DRX configurations; and providing a WUS that indicates a cause for a UE to wake-up, wherein the cause is associated with a DRX configuration of the multiple DRX configurations.

In an aspect of the disclosure, an apparatus for wireless communication at a network node is provided. The apparatus includes means for providing multiple DRX configurations; and means for providing a WUS that indicates a cause for a UE to wake-up, wherein the cause is associated with a DRX configuration of the multiple DRX configurations.

In an aspect of the disclosure, an apparatus for wireless communication at a network node is provided. The apparatus includes one or more memories, and one or more processors coupled to the one or more memories and configured to cause the network node to provide multiple DRX configurations; and provide a WUS that indicates a cause for a UE to wake-up, wherein the cause is associated with a DRX configuration of the multiple DRX configurations.

In an aspect of the disclosure, a computer-readable storage medium (e.g., a non-transitory computer-readable storage medium) storing computer executable code for wireless communication at a network node is provided. The code when executed by one or more processors causes the network node to: provide multiple DRX configurations; and provide a WUS that indicates a cause for a UE to wake-up, wherein the cause is associated with a DRX configuration of the multiple DRX configurations.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network (NW), in accordance with various aspects of the present disclosure.

FIG. 2 shows a diagram illustrating architecture of an example of a disaggregated base station, in accordance with various aspects of the present disclosure.

FIG. 3A is a diagram illustrating an example of a first subframe within a frame structure, in accordance with various aspects of the present disclosure.

FIG. 3B is a diagram illustrating an example of downlink (DL) channels within a subframe, in accordance with various aspects of the present disclosure.

FIG. 3C is a diagram illustrating an example of a second subframe within a frame structure, in accordance with various aspects of the present disclosure.

FIG. 3D is a diagram illustrating an example of uplink (UL) channels within a subframe, in accordance with various aspects of the present disclosure.

FIG. 4 is a block diagram illustrating an example of a base station in communication with a user equipment (UE) in an access network, in accordance with various aspects of the present disclosure.

FIGS. 5A, 5B, and 5C illustrate example timelines showing aspects of DRX timing, in accordance with aspects presented herein.

FIG. 6A illustrates an example of individual communication between a UE and a base station.

FIG. 6B and FIG. 6C illustrate example diagrams showing collaborative UE groups.

FIG. 7A and FIG. 7B illustrate example aspects of WUS or DCP reception for multiple DRX configurations, in accordance with aspects presented herein.

FIG. 8 is an example communication flow between one or more UEs and a base station, in accordance with aspects presented herein.

FIG. 9 is an example timeline showing aspects of DRX timing, in accordance with aspects presented herein.

FIG. 10 is an example timeline showing a relationship between latency and DRX length, in accordance with aspects presented herein.

FIG. 11 is an example timeline showing aspects of shared DRX monitoring among multiple UEs, in accordance with aspects presented herein.

FIG. 12 is an example timeline showing aspects of shared DRX monitoring among multiple UEs, in accordance with aspects presented herein.

FIG. 13 is an example communication flow between one or more UEs and a base station, in accordance with aspects presented herein.

FIG. 14A and FIG. 14B are flowcharts of methods of wireless communication, in accordance with aspects presented herein.

FIG. 15 is a flowchart of a method of wireless communication, in accordance with aspects presented herein.

FIG. 16 is a diagram illustrating an example of a hardware implementation for an example apparatus and/or network entity.

FIG. 17A and FIG. 17B are flowcharts of methods of wireless communication, in accordance with aspects presented herein.

FIG. 18 is a flowchart of a method of wireless communication, in accordance with aspects presented herein.

FIG. 19 is a diagram illustrating an example of a hardware implementation for an example network entity.

### DETAILED DESCRIPTION

A UE may be configured for discontinuous reception (DRX) in which the UE monitors for physical downlink control channel (PDCCH) transmissions discontinuously. For example, in the DRX mode, the UE may use a sleep and wake cycle (e.g., based on OFF durations during which the UE does not monitor for PDCCH transmissions and ON durations during which the UE monitors for PDCCH transmissions). In some aspects, the DRX ON duration, in which the UE monitors for PDCCH transmissions, may be referred to as an active duration. A DRX OFF duration, e.g., when the UE does not monitor for PDCCH transmissions, may be referred to as an inactive duration. During the DRX OFF duration, the UE may enter a sleep mode or a low power mode in which the UE minimizes power consumption by shutting down a radio frequency (RF) function. When the UE is in an RRC connected state, the DRX mode may also be referred to as connected mode DRX (C-DRX). In a non-DRX mode, the UE monitors for PDCCH in each subframe to check whether there is downlink data available. Continuous monitoring of the PDCCH uses more battery power at the UE, and DRX conserves battery power at the UE. The UE may receive a DRX configuration from a network, e.g., in radio resource control (RRC) signaling. The DRX configuration may indicate one or more timers or values for the UE to use in connection with the DRX, such as any of an ON duration Timer, a DRX inactivity timer, a DRX retransmission timer, a DRX UL retransmission timer, a long DRX cycle, a value of the DRX start offset, a DRX short cycle timer, and/or a short DRX cycle, among others. The UE may monitor for the PDCCH based on a configured radio network temporary identifier (RNTI). For example, the UE may be assigned an RNTI, and may use the RNTI to attempt to detect PDCCH transmissions that are directed to the UE.

In some aspects, downlink control information of power saving (DCP) (which may also be referred to as a wake up signal (WUS) or DCI format 2_6 with wake up indication information) may be used to further assist a UE in achieving added power savings. With DCP, the UE monitors for a DCP or WUS before a DRX ON duration to determine whether to wake up to monitor for PDCCH transmissions during the DRX ON duration. The DCP/WUS can be considered an early indication that enables the UE to know whether the UE is to wake up for a particular DRX ON duration or may remain in a sleep mode for a longer period of time. The use of a DCP increases power savings at the UE and helps the UE to manage the UE's wake up and sleep cycles more efficiently by allowing the UE to stay in a lower power state (e.g., during which the UE does not monitor for PDCCH transmissions) for longer periods of time. For example, as part of DCP, a WUS is transmitted to the UE in a dormant state, e.g., prior to an ON duration for DRX. The dormant state (which may also be referred to as a lower power state) may refer to a state when the UE is not actively transmitting or receiving data, but remains connected to the network. The WUS is transmitted to the UE before the DRX ON duration window to indicate to the UE to wake up for the ON duration. If the UE receives the WUS, the UE wakes up to monitor for a PDCCH transmission during the DRX ON duration. If the UE does not receive the WUS, the UE may skip PDCCH monitoring in the ON duration to achieve added power savings. Thus, the use of DCP enables the UE to wake up when there will be control signaling and avoid waking up when the base station does not have control signaling to transmit to the UE. The DCP/WUS may include a DCI format 2_6 that is scrambled by an RNTI (e.g., which may be referred to as a power saving radio network temporary identifier (PS-RNTI)).

A UE may operate in any of various modes and/or may exchange different types of communication with a network node (such as a base station) and/or with other devices (such as other UEs). Some wireless communication may be for the UE as an individual UE, e.g., communication from the base station that is directed to the UE as an individual UE. In other examples, a UE may exchange communication as part of a collaborative UE group. For example, a base station may transmit communication that is intended for one or more UEs of the collaborative UE group. A “collaborative UE group” may also be referred to by other terms such as a “collaborative group” “UE collaborative group,” a “collaborative group of UEs,” a “collaborating group,” a “group that collaborates,” or “a group for collaboration,” among other examples. In some aspects, the collaborative group may be referred to as a “virtual UE”. An individual UE may be a part of one or more collaborative groups, e.g., associated with one or more virtual UEs. Each collaborative group may have any number of two or more UEs. In some aspects, the use of a collaborative UE group or virtual UE may be referred to as UE grouping.

As presented herein, a UE may be configured with multiple DRX configurations. In some aspects, the multiple DRX configurations may include more than two DRX configurations for the UE as an individual UE (e.g., not DRX configurations for a collaborative UE group). In other aspects, the multiple DRX configurations may include at least one DRX configuration for the UE as an individual UE (e.g., a DRX configuration that is dedicated for the UE rather than a DRX configuration for a collaborative UE group) and at least one DRX configuration for a collaborative UE group that includes the UE. In order to enable a UE to operate based on multiple DRX configurations, the UE may receive a configuration for multiple identifiers assigned to the UE to distinguish the different DRX configurations for the UE. For example, the base station may assign multiple RNTIs to a single UE for different DRX configurations. Having different RNTIs for different DRX configurations may assist the UE with managing scheduling and monitoring for PDCCH in connection with DRX configurations (e.g., whether for the individual UE and/or collaborative UE groups of which the UE is a part). As an example, each collaborative UE group (e.g., which may be referred to as a virtual UE) may be assigned a separate cell radio network temporary identifier (C-RNTI) value for each C-DRX configuration (e.g., so that the virtual UE may be assigned multiple C-RNTI values corresponding to multiple C-DRX configurations). Additionally, or alternatively, an individual UE may be assigned a separate C-RNTI for each of one or more C-DRX configurations that are UE specific or dedicated for that individual UE. An MBS session may have a group radio network temporary identifier (G-RNTI) for a C-DRX configuration. Receiving assignments of different IDs (e.g., different RNTIs) enables the UE to better determine a mode of operation, as well as assisting the UE in determining whether and how to coordinate with other UEs. For example, a separate RNTI may enable a UE to determine to which of multiple DRX configurations a particular WUS applies, which enables the UE to more efficiently monitor for PDCCH transmissions according the determined DRX configuration.

As an example, the UE may receive a configuration of more than two DRX configurations for an individual UE (e.g., UE specific DRX configurations or DRX configurations that are dedicated for the UE), and may be assigned different RNTIs for the different DRX configurations. In some aspects, the UE may receive a DRX configuration for the UE as an individual UE and at least a second DRX configuration for a collaborative UE group. The UE may be a part of one or multiple collaborative UE groups (or virtual UEs) and may be assigned multiple RNTIs for DRX, e.g., a different RNTI that the UE uses for DRX for each collaborative UE group or virtual UE. As well, the C-DRX configurations may have a corresponding DCP with a corresponding PS-RNTI value. In such examples, in addition to allowing multiple C-RNTIs to assigned for each virtual UE DRX configuration (and for each UE-specific DRX configuration), multiple PS-RNTIs may be assigned for each DCP config. In some aspects, a mapping of RNTIs (e.g., C-RNTIs and/or G-RNTIs) to PS-RNTIs may be one-to-one or, many-to-one. For example, one DCP (e.g., one PS-RNTI) may map to one C-DRX configuration, or one DCP (e.g., one PS-RNTI) may map to multiple C-DRX configurations.

Each DRX configuration received by the UE may have an associated DCP, e.g., including monitoring for a WUS based on DCI format 2_6 that includes wake up indication information. For example, there may be assigned separate DCP configurations for each DRX configuration, or a single DCP configuration may be shared by multiple DRX configurations, e.g., whether for an individual UE or a collaborative UE group. In some aspects, a shared DCP may help to reduce signaling overhead. A WUS (e.g., DCP or DCI format 2_6 with a wake up indication) may provide an early indication for the wake up cause. The “cause” may also be referred to herein as a “reason,” for the WUS, a “trigger” for the WUS, a “basis for the WUS, and/or an “origin” for the WUS. The indication of the cause for the WUS enables the UE to determine the cause or reason for the UE to wake up, which can simplify UE PDCCH monitoring. For example, by being aware of the cause for the WUS, the UE will be able to determine which RNTI to search (e.g., which RNTI to use to attempt to receive a PDCCH transmission). In some aspects, the cause may be indicated, e.g., by one of more of an RNTI for the WUS, a resource for the WUS, or information in a payload of the WUS. In some aspects, multiple DCPs can be configured (e.g., in an RRC configuration that the UE receives from a base station) for a given C-DRX, and the different DCPs can be associated with (e.g., used to indicate) different causes. In some aspects, the different causes may refer to sets of one or multiple individual or virtual UE IDs or RNTIs. For example, the DCPs may be configured with separate RNTIs and/or different monitoring resources. As an example of a different monitoring resource, the different DCPs may be configured with different offsets (e.g., different ps-offset). In some aspects, the payload may include an indication that indicates the cause for the wake up. In some aspects, different bit locations, e.g., in the payload, may be assigned to different cause values (e.g., indicating a wake up for sets of one or more individual UEs or sets of one or more virtual UE RNTIs).

In examples that include UE collaboration (e.g., a collaborative UE group), the cause indicated in the DCP/WUS may indicate whether an individual UE is to wake up or the wake up is for the collaborative UE group (e.g., one or more of the UEs in the collaborative UE group/virtual UE). In examples including UE collaboration, there may be further coordination within the collaborative UE group to wake up UEs in the group. Such collaboration may allow the collaborative group to coordinate a split of the monitoring load among different constituent UEs to reduce latency for communication while maintaining or further increasing power savings at individual UEs.

As an example, the UEs within a group may cooperate for DCP monitoring, in order to reduce WUS monitoring latency without incurring in increased power consumption or while increasing reductions in power consumption. The collaboration between UEs enables the network to wake a UE within the group up more quickly if the network misses an occasion to send a DCP/WUS for a particular UE because the network can send a DCP/WUS to another UE in the collaborative group, which in turn sends an indication to the particular UE. This coordination helps to reduce latency because the network does not need to wait for a full DRX cycle completion to wake up the particular UE, without increasing UE power consumption because each UE can follow its configured DRX cycle. For example, the UEs in the group may coordinate to take turns monitoring for a DCP/WUS for the collaborative group. For example, a first UE of the group may monitor a first DCP/WUS occasion while the other UEs in the group skip monitoring for the DCP/WUS during the first DCP/WUS occasion. A second UE may monitor a second DCP/WUS occasion while the other UEs (including the first UE) skip monitoring. Individual UEs in the group may continue to take turns monitoring DCP/WUS occasions while the other UEs in the group skip the monitoring. This allows the UEs in the group to extend their power savings for longer periods of time. If the individual UE receives a DCP/WUS for the collaborative UE group, it informs the other UEs so that the group of UEs can wake up to monitor for PDCCH transmissions from the network during the DRX ON duration corresponding to the DCP/WUS.

An early cause indication in a WUS can help such coordination to be more efficient, as it enables the UE receiving the WUS to quickly determine, based on the received cause indication, the one or more UE(s) that are intended to wake up to receive the PDCCH transmission in response to the WUS. For example, the UE can determine whether the UE is intended to wake up for PDCCH monitoring based on a DRX configuration that is dedicated for the UE as an individual UE or to wake up a collaborative UE group (e.g., in response to which the UE may inform the other UEs in the group). This improves coordination and efficiency for PDCCH monitoring.

When multiple C-DRX configurations are used for multiple modes of operation as described herein, e.g., whether for DRX as an individual UE along with DRX as part of a virtual UE/collaborative UE group and/or DRX for multiple virtual UEs/groups associated with the UE, additional consideration may be made and/or communication may be exchanged to increase or achieve alignment of the various C-DRX configurations. If the network is configuring multiple C-DRX configurations that apply for a UE, the UE may request and/or control a time alignment for the C-DRX configurations. As an example, the information that the UE provides may include a request for and/or information to support a time alignment among multiple DRX configurations. For example, in a collaborative UE group example, the UE may coordinate multiple time offsets for the UEs in the collaborative UE group. In some aspects, UEs may collaborate for improved DCP monitoring in order to improve latency while maintaining or increasing power reduction in connection with C-DRX.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

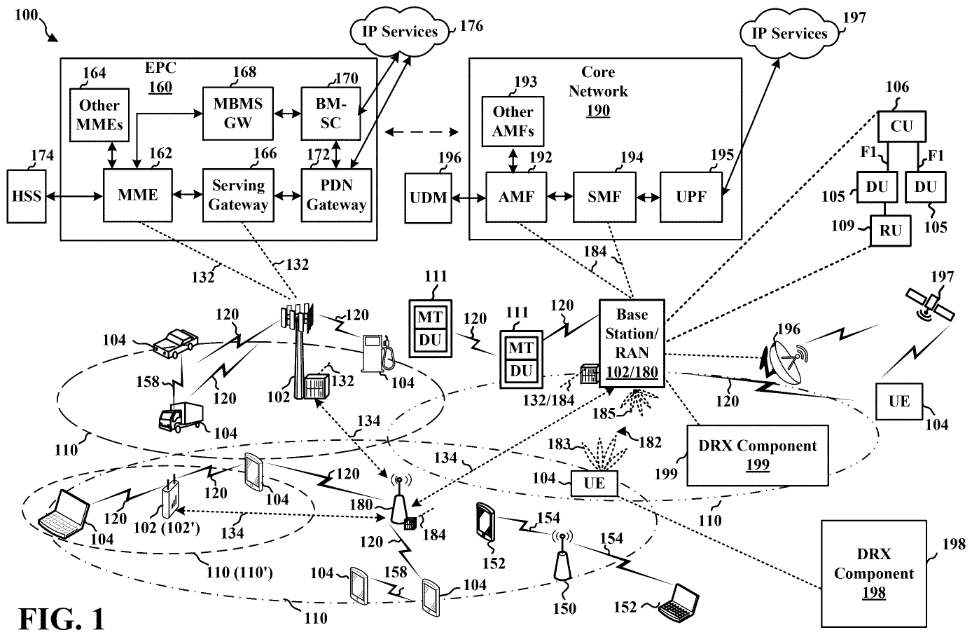

FIG. 1 is a diagram illustrating an example of a wireless communications system and an access network 100. The wireless communications system (also referred to as a wireless wide area network (WWAN)) includes base stations 102, UEs 104, an Evolved Packet Core (e.g., an EPC 160), and another core network 190 (e.g., a 5G Core (5GC)). The base stations 102 may include macrocells (high power cellular base station) and/or small cells (low power cellular base station). The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

In some aspects, a base station (e.g., one of the base stations 102 or one of base stations 180) may be referred to as a RAN and may include aggregated or disaggregated components. As an example of a disaggregated RAN, a base station may include a central unit (CU) (e.g., a CU 106), one or more distributed units (DU) (e.g., a DU 105), and/or one or more remote units (RU) (e.g., an RU 109), as illustrated in FIG. 1. A RAN may be disaggregated with a split between the RU 109 and an aggregated CU/DU. A RAN may be disaggregated with a split between the CU 106, the DU 105, and the RU 109. A RAN may be disaggregated with a split between the CU 106 and an aggregated DU/RU. The CU 106 and the one or more DUs may be connected via an F1 interface. A DU 105 and an RU 109 may be connected via a fronthaul interface. A connection between the CU 106 and a DU 105 may be referred to as a midhaul, and a connection between a DU 105 and the RU 109 may be referred to as a fronthaul. The connection between the CU 106 and the core network 190 may be referred to as the backhaul.

The RAN may be based on a functional split between various components of the RAN, e.g., between the CU 106, the DU 105, or the RU 109. The CU 106 may be configured to perform one or more aspects of a wireless communication protocol, e.g., handling one or more layers of a protocol stack, and the one or more DUs may be configured to handle other aspects of the wireless communication protocol, e.g., other layers of the protocol stack. In different implementations, the split between the layers handled by the CU and the layers handled by the DU may occur at different layers of a protocol stack. As one, non-limiting example, a DU 105 may provide a logical node to host a radio link control (RLC) layer, a medium access control (MAC) layer, and at least a portion of a physical (PHY) layer based on the functional split. An RU may provide a logical node configured to host at least a portion of the PHY layer and radio frequency (RF) processing. The CU 106 may host higher layer functions, e.g., above the RLC layer, such as a service data adaptation protocol (SDAP) layer, a packet data convergence protocol (PDCP) layer, and/or an upper layer. In other implementations, the split between the layer functions provided by the CU, the DU, or the RU may be different.

The base stations 102 may wirelessly communicate with the UEs 104. Each of the base stations 102 may provide communication coverage for a respective geographic coverage area 110. There may be overlapping geographic coverage areas. For example, a small cell may have a coverage area 111 that overlaps the respective geographic coverage area 110 of one or more base stations (e.g., one or more macro base stations, such as the base stations 102). A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE to a base station and/or downlink (DL) (also referred to as forward link) transmissions from a base station to a UE. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs may communicate with each other using device-to-device (D2D) communication links, such as a D2D communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE), Wi-Fi based on the IEEE 802.11 standard, LTE, or NR.

The wireless communications system may further include a Wi-Fi access point (AP), such as an AP 150, in communication with Wi-Fi stations (STAs), such as STAs 152, via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell may operate in a licensed and/or an unlicensed frequency spectrum. When operating in an unlicensed frequency spectrum, the small cell may employ NR and use the same unlicensed frequency spectrum (e.g., 5 GHz, or the like) as used by the AP 150. The small cell, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

A base station, whether a small cell or a large cell (e.g., a macro base station), may include and/or be referred to as an eNB, gNodeB (gNB), or another type of base station. Some base stations, such as a gNB, may operate in a traditional sub 6 GHz spectrum, in millimeter wave frequencies, and/or near millimeter wave frequencies in communication with the UEs 104. When the gNB operates in millimeter wave or near millimeter wave frequencies, the base stations 180 may be referred to as a millimeter wave base station. A millimeter wave base station may utilize beamforming 182 with the UEs 104 to compensate for the path loss and short range. The base stations 180 and the UEs 104 may each include a plurality of antennas, such as antenna elements, antenna panels, and/or antenna arrays to facilitate the beamforming.

The base stations 180 may transmit a beamformed signal to the UEs 104 in one or more transmit directions 185. The UEs 104 may receive the beamformed signal from the base stations 180 in one or more receive directions 183. The UEs 104 may also transmit a beamformed signal to the base stations 180 in one or more transmit directions (e.g., 183). The base stations 180 may receive the beamformed signal from the UEs 104 in one or more receive directions (e.g., 185). The base stations 180/UEs 104 may perform beam training to determine the best receive and transmit directions for each of the base stations 180/UEs 104. The transmit and receive directions for the base stations 180 may or may not be the same. The transmit and receive directions for the UEs 104 may or may not be the same.

The EPC 160 may include a Mobility Management Entity (e.g., an MME 162), other MMEs 164, a Serving Gateway 166, a Multimedia Broadcast Multicast Service (MBMS) Gateway (e.g., a MBMS Gateway 168), a Broadcast Multicast Service Center (BM-SC) (e.g., a BM-SC 170), and a Packet Data Network (PDN) Gateway (e.g., a PDN Gateway 172). The MME 162 may be in communication with a Home Subscriber Server (HSS) (e.g., an HSS 174). The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) (e.g., an AMF 192), other AMFs 193, a Session Management Function (SMF) 194, and a User Plane Function (UPF) (e.g., a UPF 195). The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base stations 102 may include and/or be referred to as a gNB, Node B, eNB, an access point, a base transceiver station, a radio base station, a radio transceiver, a transceiver function, a basic service set (BSS), an extended service set (ESS), a transmission reception point (TRP), network node, network entity, network equipment, or some other suitable terminology. The base stations 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN). The base stations 102 provide an access point to the EPC 160 or core network 190 for the UEs 104.

Examples of UEs include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs may be referred to as IoT devices (e.g., parking meter, gas pump, toaster, vehicles, heart monitor, etc.). The UEs may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a DRX component 198 that may be configured to receive multiple DRX configurations, where the multiple DRX configurations include: more than two DRX configurations for the UE as an individual UE, or at least a first DRX configuration for the individual UE and at least a second DRX configuration for a collaborative UE group. The DRX component 198 may be configured to monitor for control signaling based on the multiple DRX configurations. In some aspects, the DRX component 198 may be configured to receive multiple DRX configurations and receive a WUS that indicates a cause for the UE to wake up, where the cause is associated with a DRX configuration of the multiple DRX configurations. In certain aspects, the base station 102 may have a DRX component 199 that may be configured to configure multiple DRX configurations, where the multiple DRX configurations include: more than two DRX configurations for the UE as an individual UE, or at least a first DRX configuration for the individual UE and at least a second DRX configuration for a collaborative UE group. The DRX component 199 may be configured to provide control signaling based on the multiple DRX configurations. In some aspects, the DRX component 199 may be configured to configure multiple DRX configurations and provide a WUS that indicates a cause for the UE to wake up, where the cause is associated with a DRX configuration of the multiple DRX configurations.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

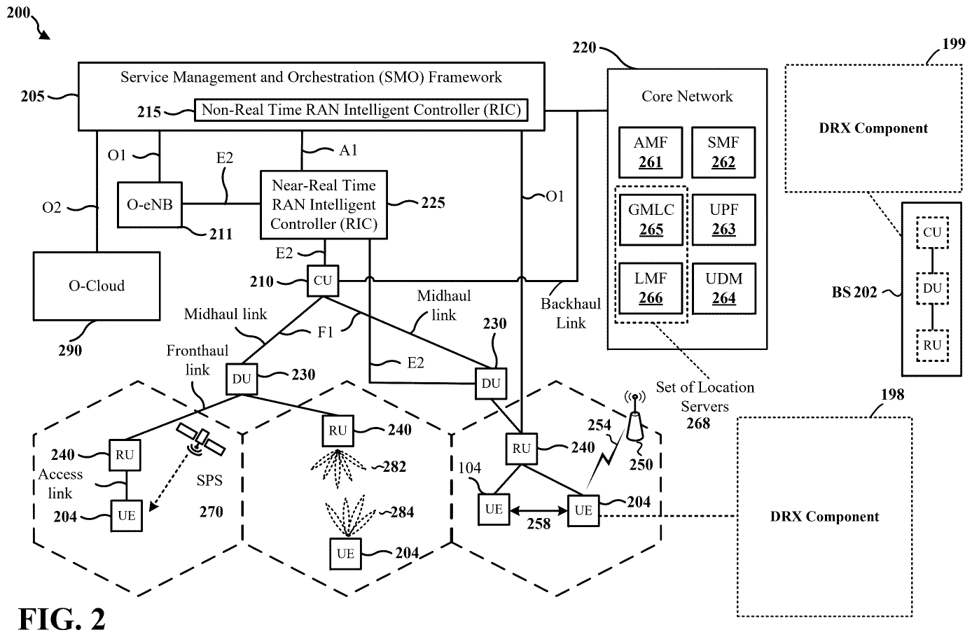

As an example, FIG. 2 shows a diagram illustrating architecture of an example of a disaggregated base station 200. The architecture of the disaggregated base station 200 may include one or more CUs (e.g., a CU 210) that can communicate directly with a core network 220 via a backhaul link, or indirectly with the core network 220 through one or more disaggregated base station units (such as a Near-Real Time (Near-RT) RAN Intelligent Controller (RIC) (e.g., a Near-RT RIC 225) via an E2 link, or a Non-Real Time (Non-RT) RIC (e.g., a Non-RT RIC 215) associated with a Service Management and Orchestration (SMO) Framework (e.g., an SMO Framework 205), or both). A CU 210 may communicate with one or more DUs (e.g., a DU 230) via respective midhaul links, such as an F1 interface. The DU 230 may communicate with one or more RUs (e.g., an RU 240) via respective fronthaul links. The RU 240 may communicate with respective UEs (e.g., a UE 204) via one or more radio frequency (RF) access links. In some implementations, the UE 204 may be simultaneously served by multiple RUs.

Each of the units, i.e., the CUs (e.g., a CU 210), the DUs (e.g., a DU 230), the RUs (e.g., an RU 240), as well as the Near-RT RICs (e.g., the Near-RT RIC 225), the Non-RT RICs (e.g., the Non-RT RIC 215), and the SMO Framework 205, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit—User Plane (CU-UP)), control plane functionality (i.e., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as an E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU 240 can be implemented to handle over the air (OTA) communication with one or more UEs (e.g., the UE 204). In some implementations, real-time and non-real-time aspects of control and user plane communication with the RU 240 can be controlled by a corresponding DU. In some scenarios, this configuration can enable the DU(s) and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements that may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs, DUs, RUs and Near-RT RICs. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs, one or more DUs, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as AI policies).

At least one of the CU 210, the DU 230, and the RU 240 may be referred to as a base station 202. Accordingly, a base station 202 may include one or more of the CU 210, the DU 230, and the RU 240 (each component indicated with dotted lines to signify that each component may or may not be included in the base station 202). The base station 202 provides an access point to the core network 220 for a UE 204. The communication links between the RUs (e.g., the RU 240) and the UEs (e.g., the UE 204) may include uplink (UL) (also referred to as reverse link) transmissions from a UE 204 to an RU 240 and/or downlink (DL) (also referred to as forward link) transmissions from an RU 240 to a UE 204.

Certain UEs may communicate with each other using D2D communication (e.g., a D2D communication link 258). The D2D communication link 258 may use the DL/UL WWAN spectrum. The D2D communication link 258 may use one or more sidelink channels. D2D communication may be through a variety of wireless D2D communications systems, such as for example, Bluetooth, Wi-Fi based on the IEEE 802.11 standard, LTE, or NR.

The wireless communications system may further include a Wi-Fi AP 250 in communication with a UE 204 (also referred to as Wi-Fi STAs) via communication link 254, e.g., in a 5 GHz unlicensed frequency spectrum or the like. When communicating in an unlicensed frequency spectrum, the UE 204/Wi-Fi AP 250 may perform a CCA prior to communicating in order to determine whether the channel is available.

The base station 202 and the UE 204 may each include a plurality of antennas, such as antenna elements, antenna panels, and/or antenna arrays to facilitate beamforming. The base station 202 may transmit a beamformed signal 282 to the UE 204 in one or more transmit directions. The UE 204 may receive the beamformed signal from the base station 202 in one or more receive directions. The UE 204 may also transmit a beamformed signal 284 to the base station 202 in one or more transmit directions. The base station 202 may receive the beamformed signal from the UE 204 in one or more receive directions. The base station 202/UE 204 may perform beam training to determine the best receive and transmit directions for each of the base station 202/UE 204. The transmit and receive directions for the base station 202 may or may not be the same. The transmit and receive directions for the UE 204 may or may not be the same.

The core network 220 may include an Access and Mobility Management Function (AMF) (e.g., an AMF 261), a Session Management Function (SMF) (e.g., an SMF 262), a User Plane Function (UPF) (e.g., a UPF 263), a Unified Data Management (UDM) (e.g., a UDM 264), one or more location servers 268, and other functional entities. The AMF 261 is the control node that processes the signaling between the UEs and the core network 220. The AMF 261 supports registration management, connection management, mobility management, and other functions. The SMF 262 supports session management and other functions. The UPF 263 supports packet routing, packet forwarding, and other functions. The UDM 264 supports the generation of authentication and key agreement (AKA) credentials, user identification handling, access authorization, and subscription management. The one or more location servers 268 are illustrated as including a Gateway Mobile Location Center (GMLC) (e.g., a GMLC 265) and a Location Management Function (LMF) (e.g., an LMF 266). However, generally, the one or more location servers 268 may include one or more location/positioning servers, which may include one or more of the GMLC 265, the LMF 266, a position determination entity (PDE), a serving mobile location center (SMLC), a mobile positioning center (MPC), or the like. The GMLC 265 and the LMF 266 support UE location services. The GMLC 265 provides an interface for clients/applications (e.g., emergency services) for accessing UE positioning information. The LMF 266 receives measurements and assistance information from the NG-RAN and the UE 204 via the AMF 261 to compute the position associated with the UE 204. The NG-RAN may utilize one or more positioning methods in order to determine the position of the UE 204. Positioning the UE 204 may involve signal measurements, a position estimate, and an optional velocity computation based on the measurements. The signal measurements may be made by the UE 204 and/or the base station 202 serving the UE 204. The signals measured may be based on one or more of a satellite positioning system (SPS) 270 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Referring again to FIG. 2, in some aspects, the UE 204, similar to the UE 104 in FIG. 1, may have a DRX component 198 that may be configured to receive multiple DRX configurations, where the multiple DRX configurations include: more than two DRX configurations for the UE as an individual UE, or at least a first DRX configuration for the individual UE and at least a second DRX configuration for a collaborative UE group. The DRX component 198 may be configured to monitor for control signaling based on the multiple DRX configurations. In some aspects, the DRX component 198 may be configured to receive multiple DRX configurations and receive a WUS that indicates a cause for the UE to wake up, where the cause is associated with a DRX configuration of the multiple DRX configurations. Similar to the base station 102 in FIG. 1, in certain aspects, the base station 202 may have a DRX component 199 that may be configured to configure multiple DRX configurations, where the multiple DRX configurations include: more than two DRX configurations for the UE as an individual UE, or at least a first DRX configuration for the individual UE and at least a second DRX configuration for a collaborative UE group. The DRX component 199 may be configured to provide control signaling based on the multiple DRX configurations. In some aspects, the DRX component 199 may be configured to configure multiple DRX configurations and provide a WUS that indicates a cause for the UE to wake up, where the cause is associated with a DRX configuration of the multiple DRX configurations.

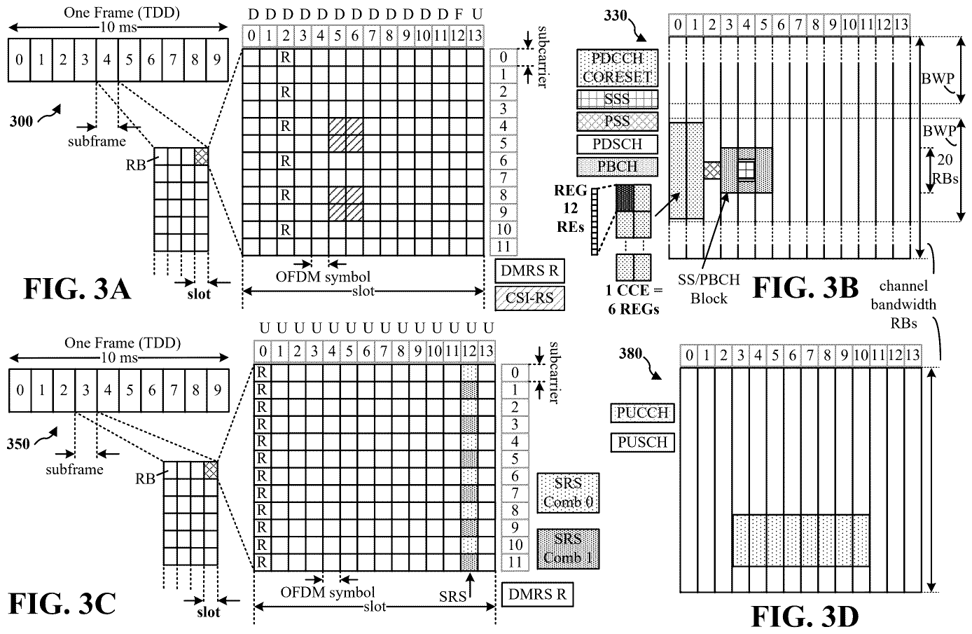

FIG. 3A is a diagram 300 illustrating an example of a first subframe within a 5G NR frame structure. FIG. 3B is a diagram 330 illustrating an example of DL channels within a 5G NR subframe. FIG. 3C is a diagram 350 illustrating an example of a second subframe within a 5G NR frame structure. FIG. 3D is a diagram 380 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 3A, 3C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 3A-3D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. As shown in Table 1, the subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 3A-3D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 3B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE, such as one of the UEs 104 of FIG. 1 and/or the UE 204 of FIG. 2, to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

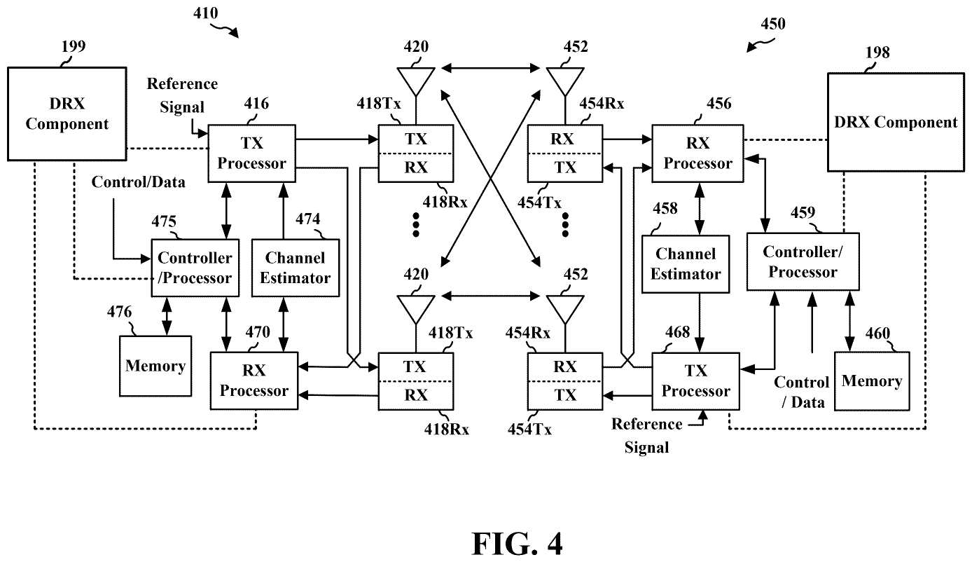

FIG. 4 is a block diagram that illustrates an example of a first wireless device that is configured to exchange wireless communication with a second wireless device. In the illustrated example of FIG. 4, the first wireless device may include a base station 410, the second wireless device may include a UE 450, and the base station 410 may be in communication with the UE 450 in an access network. As shown in FIG. 4, the base station 410 includes a transmit processor (TX processor 416), a transmitter 418Tx, a receiver 418Rx, antennas 420, a receive processor (RX processor 470), a channel estimator 474, a controller/processor 475, and at least one memory 476 (e.g., one or more memories). The example UE 450 includes antennas 452, a transmitter 454Tx, a receiver 454Rx, an RX processor 456, a channel estimator 458, a controller/processor 459, at least one memory 460 (e.g., one or more memories), and a TX processor 468. In other examples, the base station 410 and/or the UE 450 may include additional or alternative components.

In the DL, Internet protocol (IP) packets may be provided to the controller/processor 475. The controller/processor 475 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 475 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The TX processor 416 and the RX processor 470 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from the channel estimator 474 may be used to determine the coding and modulation scheme, as well as for spatial processing. The channel estimate may be derived from a reference signal and/or channel condition feedback transmitted by the UE 450. Each spatial stream may then be provided to a different antenna of the antennas 420 via a separate transmitter (e.g., the transmitter 418Tx). Each transmitter 418Tx may modulate a radio frequency (RF) carrier with a respective spatial stream for transmission.

At the UE 450, each receiver 454Rx receives a signal through its respective antenna of the antennas 452. Each receiver 454Rx recovers information modulated onto an RF carrier and provides the information to the RX processor 456. The TX processor 468 and the RX processor 456 implement layer 1 functionality associated with various signal processing functions. The RX processor 456 may perform spatial processing on the information to recover any spatial streams destined for the UE 450. If multiple spatial streams are destined for the UE 450, two or more of the multiple spatial streams may be combined by the RX processor 456 into a single OFDM symbol stream. The RX processor 456 then converts the OFDM symbol stream from the time domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 410. These soft decisions may be based on channel estimates computed by the channel estimator 458. The soft decisions are then decoded and deinterleaved to recover the data and control signals that were originally transmitted by the base station 410 on the physical channel. The data and control signals are then provided to the controller/processor 459, which implements layer 3 and layer 2 functionality.

The controller/processor 459 can be associated with the at least one memory 460 that stores program codes and data. The at least one memory 460 may be referred to as a computer-readable medium. In the UL, the controller/processor 459 provides demultiplexing between transport and logical channels, packet reassembly, deciphering, header decompression, and control signal processing to recover IP packets. The controller/processor 459 is also responsible for error detection using an ACK and/or NACK protocol to support HARQ operations.

Similar to the functionality described in connection with the DL transmission by the base station 410, the controller/processor 459 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by the channel estimator 458 from a reference signal or feedback transmitted by the base station 410 may be used by the TX processor 468 to select the appropriate coding and modulation schemes, and to facilitate spatial processing. The spatial streams generated by the TX processor 468 may be provided to different antenna of the antennas 452 via separate transmitters (e.g., the transmitter 454Tx). Each transmitter 454Tx may modulate an RF carrier with a respective spatial stream for transmission.

The UL transmission is processed at the base station 410 in a manner similar to that described in connection with the receiver function at the UE 450. Each receiver 418Rx receives a signal through its respective antenna of the antennas 420. Each receiver 418Rx recovers information modulated onto an RF carrier and provides the information to the RX processor 470.

The controller/processor 475 can be associated with the at least one memory 476 that stores program codes and data. The at least one memory 476 may be referred to as a computer-readable medium. In the UL, the controller/processor 475 provides demultiplexing between transport and logical channels, packet reassembly, deciphering, header decompression, control signal processing to recover IP packets. The controller/processor 475 is also responsible for error detection using an ACK and/or NACK protocol to support HARQ operations.

At least one of the TX processor 468, the RX processor 456, and the controller/processor 459 may be configured to perform aspects in connection with the DRX component 198 of FIG. 1.

At least one of the TX processor 416, the RX processor 470, and the controller/processor 475 may be configured to perform aspects in connection with the DRX component 199 of FIG. 1.

A UE may be configured by a base station for discontinuous reception (DRX). For example, when there is no data transmission in either direction (UL/DL), the UE may operate using the DRX mode in order to monitor for PDCCH transmissions discontinuously. For example, in the DRX mode, the UE may use a sleep and wake cycle (e.g., based on OFF durations and ON durations) to monitor for PDCCH transmissions. When the UE is in an RRC connected state, the DRX mode may also be referred to as Connected Mode DRX (C-DRX). DRX conserves battery power at the UE. In a non-DRX mode, the UE monitors for PDCCH in each subframe to check whether there is downlink data available. Continuous monitoring of the PDCCH uses more battery power at the UE.

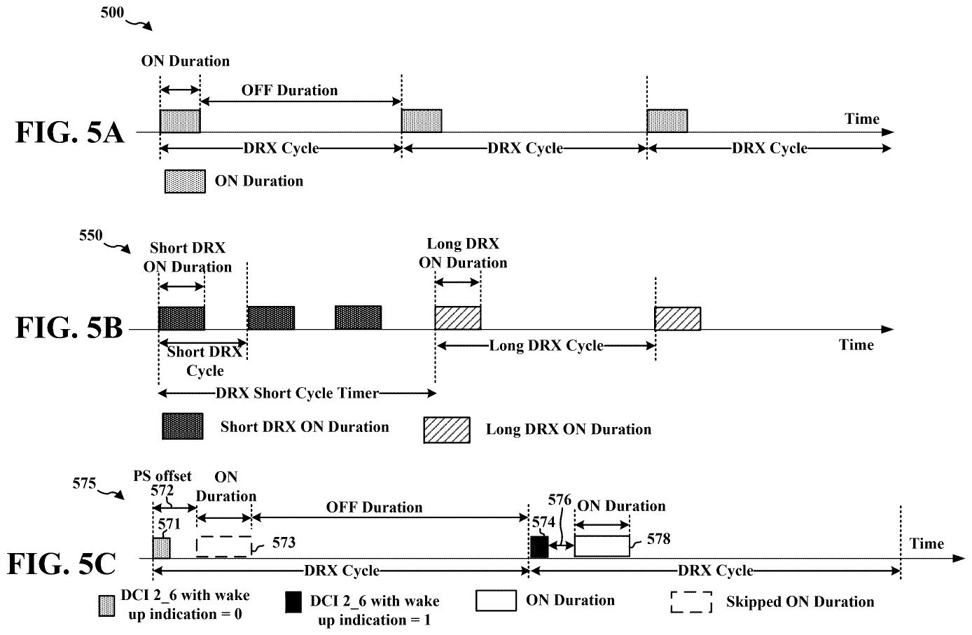

A DRX cycle may comprise a periodic repetition of ON durations in which the UE monitors for PDCCH from the base station and OFF durations during which the UE skips monitoring for PDCCH transmissions. FIG. 5A illustrates an example of a DRX cycle 500 including periodic ON durations during which the UE monitors for PDCCH and OFF durations during which the UE may not monitor for the PDCCH. The OFF duration may be referred to as a DRX opportunity. During the OFF duration, the UE does not monitor for PDCCH. The UE may enter a sleep mode or a low power mode in which the UE minimizes power consumption by shutting down a radio frequency (RF) function without detecting communication from the base station.

The UE may receive a DRX configuration from the network in RRC signaling from a base station. For example, the UE may receive the DRX configuration in an RRC Connection Setup request or an RRC connection reconfiguration request from the base station. The DRX configuration may indicate one or more timers or values. In some examples, the DRX configuration may include any of an ON duration Timer, a DRX inactivity timer, a DRX retransmission timer, a DRX UL retransmission timer, a long DRX cycle, a value of the DRX start offset, a DRX short cycle timer, and/or a short DRX cycle, among others.

The ON duration timer may correspond to a number of consecutive PDCCH subframes to be monitored or decoded when the UE wakes up from the OFF duration in the DRX Cycle. The DRX retransmission timer may correspond to a consecutive number of PDCCH subframes for the UE to monitor when a retransmission is expected by the UE. The DRX inactivity timer may correspond to an amount of time before the UE may again enter the OFF duration following successfully decoding PDCCH. The amount of time may be in terms of a transmission time interval (TTI) duration. For example, the on duration timer may give the number of consecutive PDCCH subframe(s) that need to be monitored/decoded when the UE wakes up from the OFF duration in a DRX Cycle. After a UE successfully receives downlink data, the DRX Inactivity Timer may start counting a number of subframes. If any uplink or downlink data transmissions occur while the DRX inactivity timer is running, the timer restarts. If the DRX inactivity timer expires without uplink or downlink activity, the UE may enter the DRX cycle to achieve power savings. The UE may start with a short DRX cycle.

The DRX short cycle may correspond to a first DRX cycle that the UE enters after successful expiration of DRX inactivity timer. FIG. 5B illustrates an example 550 showing an example DRX short cycle. The UE may operate using the short DRX cycle until a DRX short cycle timer expires. Once the DRX short cycle expires, the UE may enter a long DRX cycle. The example 550 in FIG. 5B also illustrates an example DRX long cycle. A DRX short cycle timer may correspond to a number of consecutive subframes during which the UE follows the short DRX cycle after the DRX inactivity timer has expired. The UE may further be able to transition to an idle mode DRX based on an RRC inactivity timer.

In some aspects, downlink control information of power saving (DCP) (which may also be referred to as a wake up signal (WUS) or DCI format 2_6 with wake up indication information), may be used to further assist a UE in achieving added power savings. Use of a DCP is designed to reduce power consumption by allowing UEs to stay in a low-power state for longer periods of time. The use of a DCP achieves such added power savings by providing control information that helps UEs to manage their wake up and sleep cycles more efficiently. For example, as part of DCP, a base station transmits a WUS to the UE in a dormant state, e.g., prior to an ON duration for DRX. The base station transmits the WUS before the DRX ON duration window to indicate to the UE to wake up for the ON duration. If the UE receives the WUS, the UE wakes up to monitor for a PDCCH transmission during the DRX ON duration. If the UE does not receive the WUS, the UE may skip PDCCH monitoring in the ON duration to achieve added power savings. Thus, the use of DCP enables the UE to wake up when there will be control signaling and avoid waking up when the base station does not have control signaling to transmit to the UE.

In some aspects, a UE configured with DRX mode operation can be provided information for detection of a DCI format 2_6 (which may also be referred to herein as a WUS or DCP) in a PDCCH reception on a cell (e.g., such as the primary cell (PCell) or on a special cell (SpCell)). The UE may receive a configuration for a radio network temporary identifier (RNTI) to use for DCI format 2_6, such as a power saving radio network temporary identifier (PS-RNTI). The UE may receive a configuration for a number of search space sets to monitor PDCCH for detection of DCI format 2_6 (e.g., on the active DL BWP of the PCell or of the SpCell according to a common search space), a payload size for the DCI format 2_6, a location in the DCI format 2_6 of a wake up indication bit. In some aspects, a first value (e.g., a ‘0’ value) for the wake up indication bit in the DCI format 2_6 indicates to not start a timer associated with the DRX ON duration (e.g., which may be referred to as a drx-onDurationTimer) for the next long DRX cycle. In this example, the UE may remain in a sleep mode and skip monitoring for PDCCH during the ON duration. A second value (e.g., a ‘1’ value) for the wake up indication bit indicates for the UE to start the drx-onDurationTimer for the next long DRX cycle, e.g., for the UE to wake up for the ON duration in order to monitor for a PDCCH transmission. FIG. 5C illustrates an example timeline 575 for DRX with DCP, e.g., monitoring for a WUS based on DCI format 2_6. In FIG. 5C, the WUS (e.g., DCI format 2_6 with wake up indication information) at 571 includes a wake up indication value that indicates that the UE does not need to wake up. Therefore, the UE may remain in a sleep mode during the ON duration 573 and may skip PDCCH monitoring during the ON duration 573. This enables the UE to achieve added power savings by skipping PDCCH monitoring during the ON duration 573. The WUS 574 has a wake up indication value that indicates for the UE to wake up during the ON duration 578. Based on receiving the WUS 574, the UE wakes up to monitor for PDCCH during the On duration 578. The UE monitors for the DCI format 2_6 at a time offset 572 (e.g., which may be referred to as a power saving (PS) offset). The DCI format 2_6 is spaced in time from the beginning of the ON duration by a time gap 576.

For DCP, a WUS is carried in a DCI format 2_6, scrambled by a RNTI, e.g., which may be called a PS-RNTI. This DCI is used for providing the UE with power saving information outside DRX Active Time for one or more UEs. As described in connection with FIG. 5A and FIG. 5B, monitoring occasions for DRX can be configured by RRC relative to the drx-onDurationTimer of Long DRX. MBS C-DRX configurations do not include DCP.

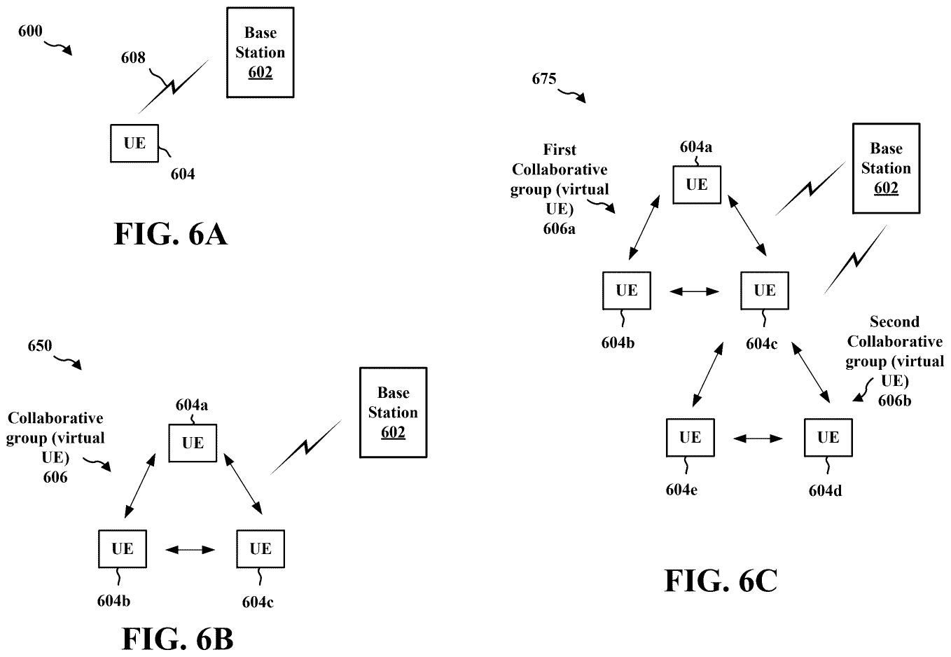

A UE may operate in any of various modes and/or may exchange different types of communication with a network node (such as a base station) and/or with other devices such as other UEs. Some wireless communication may be for an individual UE. As an example FIG. 6A shows a diagram 600 illustrating that a UE 604 may receive unicast signaling 608 from a base station 602, e.g., with communication that is for the individual UE 604. In other examples, a UE may exchange communication as part of a collaborative UE group. FIG. 6B is a diagram 650 that illustrates an example of UE collaboration. FIG. 6B illustrates a set of multiple UEs (e.g., UE 604a, UE 604b, and UE 604c) that form or are included in a collaborative UE group 606, which may also be referred to by other names such as a “collaborative group” “UE collaborative group,” a “collaborative group of UEs,” a “collaborating group,” a “group that collaborates,” or “a group for collaboration,” among other examples. In some aspects, the collaborative group 606 may be referred to as a “virtual UE”. An individual UE may be a part of one or more collaborative groups, e.g., associated with one or more virtual UEs. FIG. 6C illustrates an example 675 in which the UE 604c is a part of both the first collaborative UE group 606a (e.g., first virtual UE) with the UE 604a and the UE 604b as well as being a part of the second collaborative UE group 606b (e.g., second virtual UE) with the UE 604d and the UE 604e. Although the collaborative groups are shown with sets of three UEs, this is merely to illustrate the concept of a group. Each collaborative group may have any number of two or more UEs. In some aspects, the use of a collaborative UE group or virtual UE may be referred to as UE grouping.

A UE in an RRC connected mode may be configured with up to two C-DRX configurations (e.g., for different cells that belong to different frequency ranges such as FR1 and FR2). In some aspects, a C-DRX configuration for an individual UE may be referred to as a UE dedicated C-DRX configuration, an individual C-DRX configuration, or a UE specific D-DRX configuration. A multicast broadcast service (MBS) may have an associated C-DRX configuration, e.g., which is independent of an individual UE's C-DRX configuration. In some aspects, different C-DRX configurations may be provided for each MBS group. As an example, the DRX configuration for an MBS may be provided in a DRX-ConfigPTM information element (IE), e.g., that configures DRX related parameters for point to multipoint (PTM) transmission.

For example, for MBS broadcast or multicast, DRX functionality may be configured per G-RNTI or per G-CS-RNTI that controls the UE's PDCCH monitoring activity. When a UE is in an RRC idle state, an RRC inactive state, or an RRC connected state, if broadcast or multicast DRX is configured for a G-RNTI or G-CS-RNTI, the UE may monitor the PDCCH for this G-RNTI or G-CS-RNTI discontinuously using the broadcast or multicast DRX operation. The UE performs broadcast DRX operation or multicast DRX operation independently for each G-RNTI or G-CS-RNTI and independently from DRX operation based on a DRX configuration dedicated for the UE. MBS DRX configurations do not include DCP.

As presented herein, in order to enable a UE to operate based on multiple DRX configurations, the UE may receive a configuration for multiple identifiers assigned to the UE to distinguish the different DRX configurations for the UE. For example, the base station may assign multiple RNTIs to a single UE for managing scheduling and DRX configurations of the individual UE and associated collaborative groups. For example, rather than being assigned a single RNTI (e.g., a cell radio network temporary identifier (C-RNTI)), the UE may be assigned multiple RNTIs (e.g., multiple C-RNTIs), in which different RNTIs are associated with different DRX configurations for the UE. As an example, each virtual UE may be assigned a separate C-RNTI value for each C-DRX configuration (e.g., so that the virtual UE may be assigned multiple C-RNTI values corresponding to multiple C-DRX configurations). Additionally, or alternatively, an individual UE may be assigned a separate C-RNTI for each of one or more C-DRX configurations that are UE specific or dedicated for that individual UE. An MBS session may have a group radio network temporary identifier (G-RNTI) for a C-DRX configuration. As an example, the UE may receive a configuration of more than two DRX configurations for an individual UE (e.g., UE specific DRX configurations or DRX configurations that are dedicated for the UE), and may be assigned different RNTIs for the different DRX configurations. In some aspects, the UE may receive a DRX configuration for the UE as an individual UE and at least a second DRX configuration for a collaborative UE group. The UE may be a part of one or multiple collaborative UE groups (or virtual UEs) and may be assigned multiple RNTIs for DRX, e.g., a different RNTI that the UE uses for DRX for each collaborative UE group or virtual UE. In some aspects, a collaborative UE group or virtual UE may be referred to as, or considered, a “co-located antenna group,” and the co-located antenna group may have (e.g., be assigned) its own RNTI that is used for DRX. In some aspects, a base station may also configure CSI-RS and CQI reporting in common for the group (e.g., the collaborative UE group, virtual UE or co-located antenna group). Providing assignments of different IDs (e.g., different RNTIs) can benefit a UE by enabling the UE to better determine a mode of operation, as well as assisting the UE in determining whether and how to coordinate with other UEs. As well, the C-DRX configurations may have a corresponding DCP with a corresponding PS-RNTI value. In such examples, in addition to allowing multiple C-RNTIs to assigned for each virtual UE DRX configuration (and for each UE-specific DRX configuration), multiple PS-RNTIs may be assigned for each DCP config. In some aspects, a mapping of RNTIs (e.g., C-RNTIs and/or G-RNTIs) to PS-RNTIs may be one-to-one or, many-to-one. For example, one DCP (e.g., one PS-RNTI) may map to one C-DRX configuration, or one DCP (e.g., one PS-RNTI) may map to multiple C-DRX configurations.

In some aspects, multiple C-DRX configurations may be provided for individual UEs and/or collaborative UE groups/virtual UEs. As an example, the UE may be configured with one or more C-DRX configurations (e.g., in addition to one or more dedicated C-DRX configurations for the UE as an individual UE) associated with collaborative UE groups/virtual UEs of which the UE is a part. For example, the UE 604c in FIG. 6C may receive one or more DRX configurations that are for the UE 604c as an individual UE (e.g., UE dedicated DRX configurations or UE specific DRX configurations). The UE 604c may also receive one or more DRX configurations associated with the first collaborative UE group 606a and/or one or more DRX configurations associated with the second collaborative UE group 606b.

In some aspects, a base station may indicate that one C-DRX configuration (e.g., a single C-DRX configuration) is associated with multiple collaborative UE groups/virtual UEs. For example, the base station 602 in FIG. 6C may indicate that a single DRX configuration is associated with, or to be used with, the first collaborative UE group 606a and the second collaborative UE group 606b.

In some aspects, a UE dedicated C-DRX configuration (e.g., for an individual UE) can also be shared or used in common with one or more associated collaborative UE groups/virtual UEs. As an example, the UE 604c in FIG. 6C may receive a DRX configuration for the UE 604c as an individual UE, and the base station may also indicate for the first collaborative UE group 606a to use the DRX configuration that was configured for the UE 604c. In some aspects, each C-RNTI can be associated with one or more C-DRX configurations.

Each DRX configuration received by the UE may have an associated DCP, e.g., including monitoring for a WUS based on DCI format 2_6 that includes wake up indication information. For example, there may be separate DCP configurations for each DRX configuration, or a single DCP configuration may be shared by multiple DRX configurations. In some aspects, a shared DCP may help to reduce signaling overhead. In some aspects, there may be a maximum number of configurable C-DRX configurations. The maximum number may be based on a rule that is defined in a wireless telecommunications standard, in some examples. In some examples, the maximum number of configurable C-DRX configurations may be based on information reported by the UE to the base station, e.g., such as information in a UE capability report or other report transmitted by the UE to the base station. In some aspects, the base station may indicate the maximum number of configurable C-DRX configurations to the UE.

When a common C-DRX configuration is used for multiple modes of operation (e.g., modes as an individual UE and UE in collaborative UE group/virtual UE and/or multiple virtual UEs/collaborative groups associated with the UE), the WUS (e.g., DCP) may provide an early indication for the cause (e.g., reason, trigger, origin, basis, etc.) for the WUS. This indication of the cause in the WUS enables the UE to determine the cause or reason for the UE to wake up. For example, by determining the cause from the WUS, the UE can simplify UE PDCCH monitoring, because the UE will be able to determine which RNTI to search (e.g., which RNTI to use to attempt to receive a PDCCH transmission).

In examples including UE collaboration, there may be further coordination within the collaborative UE group to wake up UEs in the group. While the collaboration may allow the group to coordinate a split of the work (e.g., monitoring for communication) among different constituent UEs. An early indication, e.g., WUS, can help to speed up such coordination.

In some aspects, the DCP framework may be used to provide an early indication for the wake up cause (e.g., reason, trigger, basis, origin, etc.). In examples that include UE collaboration (e.g., a collaborative UE group), the “cause” or “reason” indicated in the WUS may indicate whether an individual UE is to wake up or the wake up is for the collaboration group (e.g., each of the UEs in the collaborative UE group/virtual UE). In some aspects, the cause or reason indicated in the WUS may differentiate between individual UEs. In some aspects, the cause or reason indicated in the WUS may differentiate between virtual UEs (e.g., collaborative UE groups). In some aspects, the cause or reason indicated in the WUS may differentiate between sets of virtual UEs (e.g., collaborative UE groups). For example, a UE may receive a WUS that includes a cause indication that the UE is to wake up as an individual UE or that an individual UE in a collaborative UE group is to wake up. As another example, the UE may receive a WUS with a cause indication that a collaborative UE group is to wake up. As another example, the UE may receive a WUS with a cause indication that a set of collaborative UE groups are to wake up. As another example, the UE may receive a WUS with a cause indication that one or more UEs within a collaborative UE group are to wake up.

In some aspects, multiple DCPs can be configured (e.g., in an RRC configuration that the UE receives from a base station) for a given C-DRX, and the different DCPs can be associated with (e.g., used to indicate) different causes. As described above, the different causes may refer to sets of one or multiple individual or virtual UE IDs or RNTIs. For example, the DCPs may be configured with separate RNTIs and/or different monitoring resources. As an example of a different monitoring resource, the different DCPs may be configured with different offsets (e.g., different ps-offset). Table 2, Table 3, and Table 4 illustrate examples of multiple DCPs that can indicate wake up cases for different purposes (e.g., to wake up an individual UE for different DRX configurations having different RNTIs, to wake up individual Us within a collaborative UL group (e.g., virtual UL), to wake up sets of Us within a collaborative UL group, or to wake up sets of virtual UEs (e.g., sets of collaborative UL groups)). In the example in Table 2, the different DCPs are configured with different monitoring resources, e.g., different PS-offsets. In the example in Table 3, the different DCPs are configured with different PS-RNTIs. In the example in Table 4, a combination of PS-offset and PS-RNTI are used to differentiate between different DCPs and the corresponding causes. The tables are merely examples to illustrate the concept of configurations for different DCPs (using different monitoring resources and/or RNTIs) to indicate a cause associated with a WUS (e.g., DCP or DCI format 2_6 with a wake up indication). Any combination of aspects described in connection with the example tables may be used.

TABLE 2

| | | Monitoring |
|---|---|---|
| DCP | Cause | Resource |
| DCP 1 | Individual UE wake up (e.g., RNTI 1) | PS offset 1 |
| DCP 2 | Individual UE wake up (e.g., RNTI 2) | PS offset 2 |
| DCP 3 | Virtual UE ID 1 wake up (e.g., RNTI 3) | PS offset 3 |
| DCP 4 | Virtual UE ID 2 wake up (e.g., RNTI 4) | PS offset 4 |
| DCP 5 | UE 1 and UE 2 in Virtual UE ID 1 wake up | PS offset 5 |
| DCP 6 | UE 3 and UE 4 in Virtual UE ID 1 wake up | PS offset 6 |
| DCP 7 | Virtual UE ID 1 and Virtual UE ID 2 wake up | PS offset 7 |

TABLE 3

| DCP | Cause | PS-RNTI |
|---|---|---|
| DCP 1 | Individual UE wake up (e.g., RNTI 1) | PS-RNTI 1 |
| DCP 2 | Individual UE wake up (e.g., RNTI 2) | PS-RNTI 2 |
| DCP 3 | Virtual UE ID 1 wake up (e.g., RNTI 3) | PS-RNTI 3 |
| DCP 4 | Virtual UE ID 2 wake up (e.g., RNTI 4) | PS-RNTI 4 |
| DCP 5 | UE 1 and UE 2 in Virtual UE ID 1 wake up | PS-RNTI 5 |
| DCP 6 | UE 3 and UE 4 in Virtual UE ID 1 wake up | PS-RNTI 6 |
| DCP 7 | Virtual UE ID 1 and Virtual UE ID 2 wake up | PS-RNTI 6 |

TABLE 4

| DCP | Cause | Parameter(s) |
|---|---|---|
| DCP 1 | Individual UE wake up (e.g., RNTI 1) | PS-RNTI 1, PS offset 1 |
| DCP 2 | Individual UE wake up (e.g., RNTI 2) | PS-RNTI 2, PS offset 1 |
| DCP 3 | Virtual UE ID 1 wake up (e.g., RNTI 3) | PS-RNTI 3, PS offset 2 |
| DCP 4 | Virtual UE ID 2 wake up (e.g., RNTI 4) | PS-RNTI 4, PS offset 2 |
| DCP 5 | UE 1 and UE 2 in Virtual UE ID 1 wake up | PS-RNTI 5, PS offset 3 |
| DCP 6 | UE 3 and UE 4 in Virtual UE ID 1 wake up | PS-RNTI 6, PS offset 3 |
| DCP 7 | Virtual UE ID 1 and Virtual UE ID 2 wake up | PS-RNTI 7 and/or PS offset 3 |

For example, the UE may monitor for a DCP (e.g., which may also be referred to as a WUS or DCI format 2_6 with a wake up indication) based on the configured DCPs. When the UE receives a DCP (e.g., WUS or DCI format 2_6 with a wake up indication), the UE identifies the cause for the DCP based on the corresponding monitoring resource in which the DCP was received and/or the PS-RNTI used for the DCP.

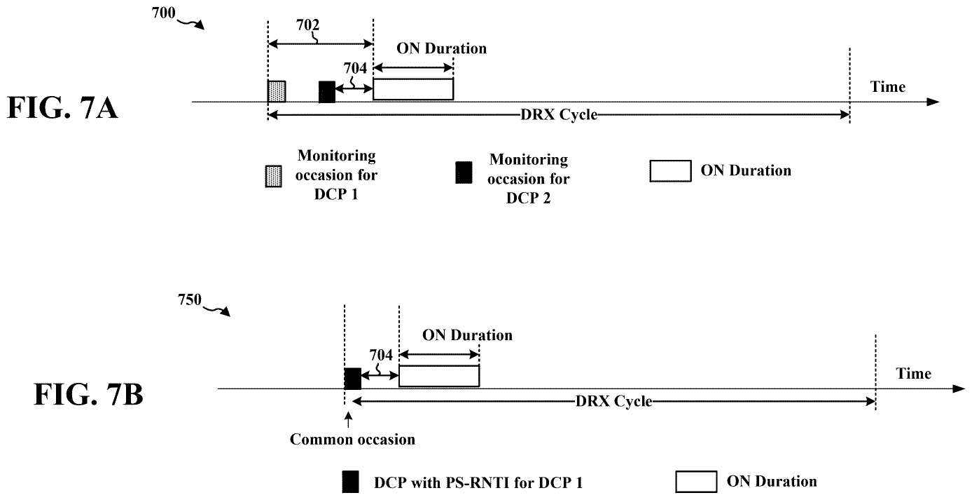

FIG. 7A illustrates an example timeline 700 showing different PS offsets (e.g., 702 and 706) that are associated with different DCPs. DCP 1 may be associated with a first cause, and DCP 2 may be indicated with a second cause. Depending on the PS offset at which the UE receives a DCP, WUS, or DCI 2_6 with a wake up indication, the UE may determine the corresponding cause. In FIG. 7B, the example timeline 750 shows a single PS-offset 704 (which may be referred to as a common PS offset), and the UE determines that the cause is for DCP 1 based on the PS-RNTI of the received DCP, WUS, or DCI 2_6.

In some aspects, a common DCP configuration may be used in connection with the different DRX configurations, and the payload of the common DCP (e.g., DCI format 2_6) can carry the information about the cause. In this example, the UE determines the information about the cause from the DCI format 2_6 (e.g., DCP or WUS) payload and determines whether to wake up and/or whether to coordinate with other UEs in the collaborative UE group (virtual UE) based on the cause indicated in the payload. In some aspects, different bit locations may be assigned to different cause values (e.g., indicating a wake up for sets of one or more individual UEs or sets of one or more virtual UE RNTIs). In some aspects, the different bit locations and the corresponding causes may be indicated to the UE in an RRC configuration from the base station. For example, the UE may receive an RRC configuration for a bitmap that associates a payload bit location with a particular wake up cause.

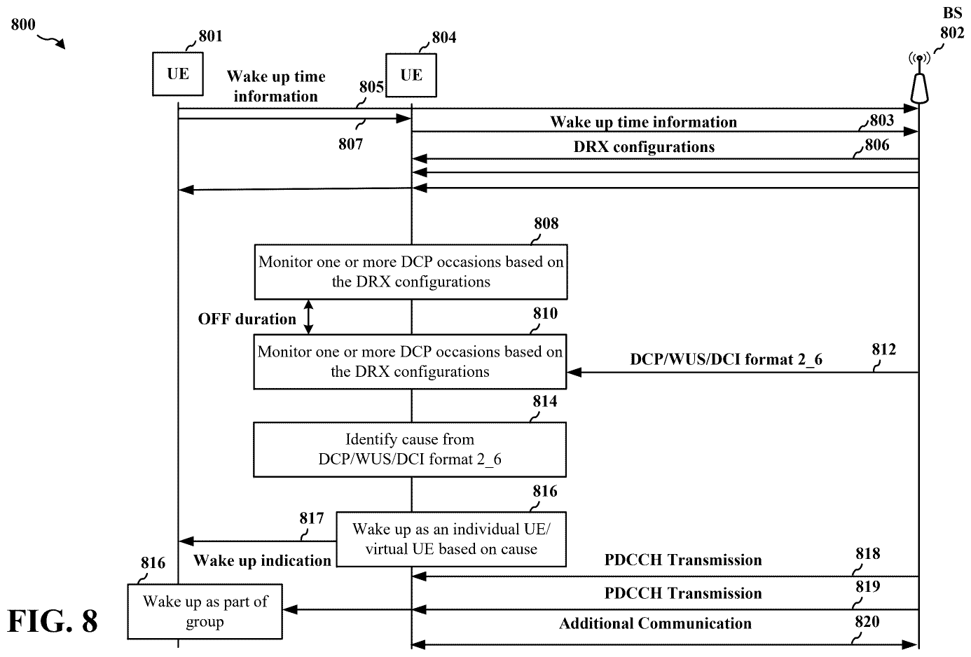

FIG. 8 illustrates an example communication flow 800 between a UE 804 and a base station 802. The aspects performed by the base station 802 may be performed by a network node that may include one or more components of a base station. For example, a network node may correspond to a base station in aggregation or one or more disaggregated components of a base station, such as one or more of an RU, DU, and/or CU, as described in connection with FIG. 1 and FIG. 2. As illustrated at 806, the UE 804 may receive multiple DRX configurations from the base station 802. Although indicated with separate lines in FIG. 8, the multiple DRX configurations may be received in a single message or in separate messages from a base station. In some aspects, the DRX configurations may be indicated to the UE 804 in RRC signaling from the base station 802. The UE may be assigned multiple RNTIs for managing the different DRX configurations. As described herein, the multiple DRX configurations may include multiple DRX configurations for the UE 804 as an individual UE, and the UE may receive a different RNTI for each DRX configuration, in some aspects. In some aspects, the multiple DRX configurations may be for multiple collaborative UE groups (e.g., virtual UEs) that include the UE 804, and the UE may receive different RNTIs for different DRX configurations. In some aspects, the multiple DRX configurations may include at least one DRX configuration for the UE 804 as an individual UE, and at least one DRX configuration for a collaborative UE group (virtual UE) that includes the UE 804, and the UE may receive different RNTIs for different DRX configurations.

As illustrated at 808 and 810, the UE may monitor one or more DCP occasions based on the DRX configurations. As shown, the UE may return to a sleep mode during DRX OFF durations between the monitoring occasions. FIG. 8 illustrates that the UE 804 may receive a DCP 812 (which may also be referred to as a WUS or DCI format 2_6 with a wake up indication, in some examples) that indicates for the UE 804 to wake up in a DRX ON duration to monitor for a PDCCH transmission 818 from the base station 802.

In some aspects, the DCP 812 may indicate a cause for the wake up. As described in connection with Tables 2, 3, and/or 4, and FIGS. 7A and 7B, different DCPs may be configured for different DRX configurations. For example, the UE 804 may identify the cause, at 814, based on the monitoring occasion in which the DCP 812 was received and/or a PS-RNTI used with the DCP 812 (e.g., a PS-RNTI with which the DCP is scrambled. In some aspects, the DCP payload may include an indication of the cause, as described herein. For example, one or more of the configurations provided at 806 may associated a monitoring resource, a PS-RNTI, and/or one or more payload bits with a particular cause. The UE 804 may use the configuration to determine the cause indicated by the DCP 812.

At 816, the UE 804 wakes up in response to the DCP 812 and based on the cause identified from the DCP 812. The UE can then receive the PDCCH transmission 818 from the base station, e.g., during a corresponding DRX ON duration. The PDCCH transmission 818 may schedule additional downlink and/or uplink communication, such as PDSCH, PUSCH, and/or PUCCH, for example. The UE 804 may exchange the additional communication 820 based on the received PDCCH, in some aspects.

When a common DCP configuration (e.g., DCI 2_6) is used to indicate whether the wake up indication is for the UE 804 as an individual UE or based on an association with virtual UE (or collaborative UE group), the common DCP configuration may include a common resource configuration (e.g., a single or same PS offset) as shown in FIG. 7B. However, a virtual UE or collaborative UE group may take longer to wake up than the time for an individual UE to wake up, because the UEs in the collaborative group/virtual UE coordinate (e.g., exchange communication) before being ready to transmit or receive in response to the DCP 812.

In some aspects, the base station 802 may receive information about the minimum time supported by a UE for wake up in a collaborative UE group/virtual UE. As shown at 803, the UE 804 may transmit to the base station 802 information about its wake up time for a collaborative UE group. Similarly, one or more UEs, such as UE 801, may also transmit to the base station 802 information about its wake up time for a collaborative UE group, as shown at 805. For example, the UE 801 and the UE 804 may both be part of a collaborative UE group, e.g., as described in connection with FIG. 6B or 6C.

For example, each UE in a collaborative UE group may indicate multiple minimum wake up times e.g., at least one minimum wake up time value for the UE's individual wake up in connection with a DRX for the UE as an individual UE, and one or multiple minimum wake up time values when the UE is part of a group. In some aspects, the UE may indicate different minimum wake up times associated with different groups/virtual UEs. In some aspects, the UE 804 may indicate a minimum wake up time value for a group, the time value being associated with this UE 804 (e.g., so that the UE 804 reports its own minimum wake up time value for waking up in connection with a collaborative UE group). In some aspects, the UE 804 may indicate a minimum wake up time value a representative of the whole group of UEs/virtual UE.

For a group/virtual UE, the base station 802 may receive this wake up time information from one or multiple constituent UEs, e.g., as shown at 803 and/or 805. In some aspects, the base station 802 may collect individual minimum wake up times from multiple UEs (e.g., as shown at 803 and 805), and may calculate a minimum time for the group/virtual UE. For example, the base station 802 may configure a common monitoring resource (e.g., a common PS offset) at a DRX configuration provided at 806 for the DCP based on the calculated minimum wake up time for the group/virtual UE. In some aspects, common monitoring resources (e.g., PS offset) may be determined based on the shortest time reported by the UEs for wake up of the associated UE/group. In some aspects, common monitoring resources (e.g., PS offset) may be determined based on the longest time reported by the UEs for wake up of the associated UE/group.

As the timelines for wake up of the individual UE or group of UEs can be different, the actual time for starting monitoring PDCCH in the DRX ON duration can be differently assumed and/or configured for the UE 804 as an individual UEs in comparison to a DRX ON duration for the UE 804 as part of a group of UEs (e.g., a collaborative UE group).

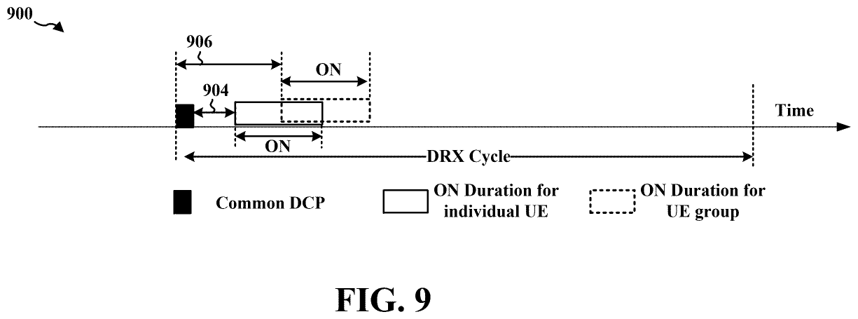

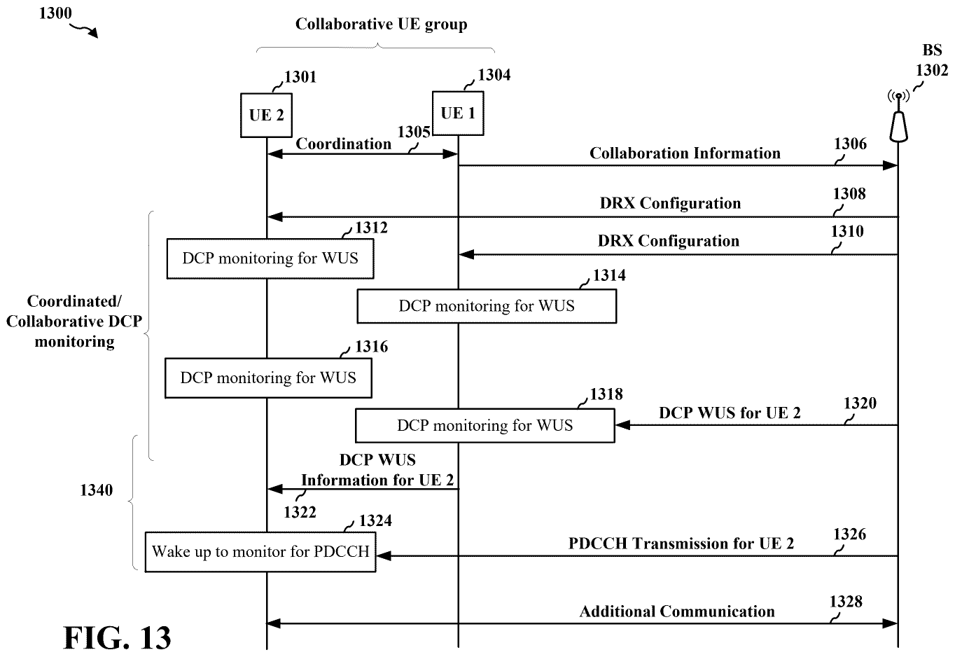

For example, a PS offset can be selected based on the individual UE's wake up time. In this example, if the UE 804 is to wake up as an individual UE, the UE may start monitoring for PDCCH from the start of the ON duration. But if the virtual UE/group is to wake up, they may start monitoring for the associated PDCCH at a later time, e.g., following a configured or indicated time offset. FIG. 9 illustrates an example with a common DCP monitoring occasion (e.g., which is common to both a DRX configuration for an individual UE and a DRX configuration for the UE as part of a collaborative UE group). FIG. 9 illustrates an example timeline 900 showing the timing at which the UE may start to monitor for PDCCH in an ON duration for the UE as an individual UE that is spaced from the DCP by a shorter time 904 than the timing at which the UE may start to monitor for PDCCH as part of a collaborative group, which is spaced from the DCP by a time 906. As an example, FIG. 13 shows a time 1340 between a DCP and a UE 1301 in a collaborative UE group waking up to monitor for a PDCCH transmission. The additional time may be based on the coordination between the UEs (e.g., time for the UE 1304 to send an indication of the DCP to the UE 1301). The different time offsets may be configured, e.g., in RRC signaling to the UE, and/or may be indicated in other signaling from the base station. FIG. 8 illustrates an example in which the UE 804 may determine that the cause in the DCP 812 is to wake up a group of UEs (e.g., a collaborative UE group or virtual UE), at 816. The UE 804 may then coordinate with the other UE(s) in the group, e.g., by transmitting an indication 817 to wake up. As shown for the UE 801 at 821, the other UE(s) in the group may wake up to monitor for a PDCCH transmission 819 for the group, e.g., which may be received by both the UE 801 and the UE 804. The coordination between the UEs in order for both UEs to be awake and ready to receive the PDCCH transmission 819 takes additional time beyond the time for the UE 804 to wake up as an individual UE.

When multiple C-DRX configurations are used for multiple modes of operation as described herein, e.g., whether for DRX as an individual UE along with DRX as part of a virtual UE/collaborative UE group and/or DRX for multiple virtual UEs/groups associated with the UE 804), additional consideration and/or communication may be exchanged to increase or achieve alignment of the various C-DRX configurations.

If the network is configuring multiple C-DRX configurations that apply for a UE, the UE may request and/or control a time alignment for the C-DRX configurations. As an example, the information that the UE provides at 803 may include a request for and/or information to support a time alignment among multiple DRX configurations. In some aspects, the UE 804 may indicate one or more preferred time offsets to the base station 802. For example, in a collaborative UE group example, the UE 804 (as a virtual UE) may coordinate multiple time offsets for the served physical UEs (e.g., UE 801 is an example of a served UE for a collaborative UE group that may be served by the UE 804). The UEs in the group may indicate the preferred time offsets directly to the base station in a UE collaboration scenario, e.g., as shown at 803 and 805. In some aspects, in a UE collaboration example, a virtual UE can coordinate multiple offsets for the served physical UEs. The UEs in the group, as shown for the UE 801, at 807, may indicate the preferred time offsets to the virtual UE (e.g., UE 804), and the virtual UE may indicate the information to the base station, at 803, as a representative of the group of UEs, based on the information received from individual UEs in the group. If the multiple C-DRX configurations are aligned, a common wake up signal (e.g., DCP) may be used to provide an indication to wake up for the multiple C-DRX configurations.

If the C-DRX configurations of a UE are misaligned, the DCP monitoring occasions (or even the DCP) can be common to the multiple C-DRX configurations. In some aspects, a different time offset for the common DCP monitoring occasions may be used for each of the multiple C-DRX configurations.

In some aspects, UEs may collaborate for improved DCP monitoring in order to improve latency while maintaining or increasing power reduction in connection with C-DRX.

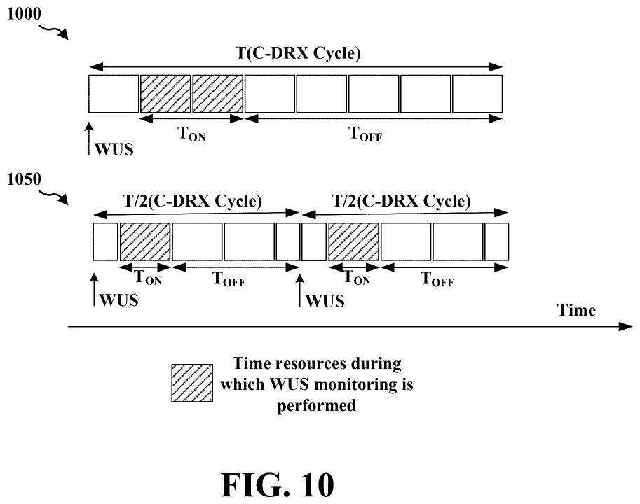

FIG. 10 illustrates a time diagram 1000 for a DRX cycle having a period T, which includes an ON duration (T_{ON}) and an OFF duration (T_{OFF}). The base station sends a WUS before the beginning of the ON duration, if the network wants to wake up the UE for the upcoming ON duration. Each time, the base station intends to send a transmission to the UE, the base station waits for the WUS opportunity to wake up the UE. The duration of the DRX cycle introduces latency while the base station waits for the WUS occasion. The latency is increased if the UE is configured with a longer OFF duration for the DRX cycle. To reduce latency, the DRX duration can be reduced, as shown for the time diagram 1050 having a DRX cycle with a period of T/2. However, the UE will then monitor for the WUS more frequently, and consume more power. A longer OFF duration enables the UE to achieve additional power savings. Thus, there is a trade off between latency and power consumption for DRX of the UE.

A reduction in power consumption corresponds to an increase in C-DRX duration, which leads to increased latency. A reduction in latency may correspond to a decrease in DRX duration, which leads to increased power consumption.

As presented herein, the UEs within a group (e.g., a collaborative UE group or virtual UE group such as described in connection with any of FIG. 6B, 6C, or 8) may include UE cooperation for DCP monitoring, in order to reduce WUS monitoring latency without incurring in increased power consumption or while increasing reductions in power consumption.

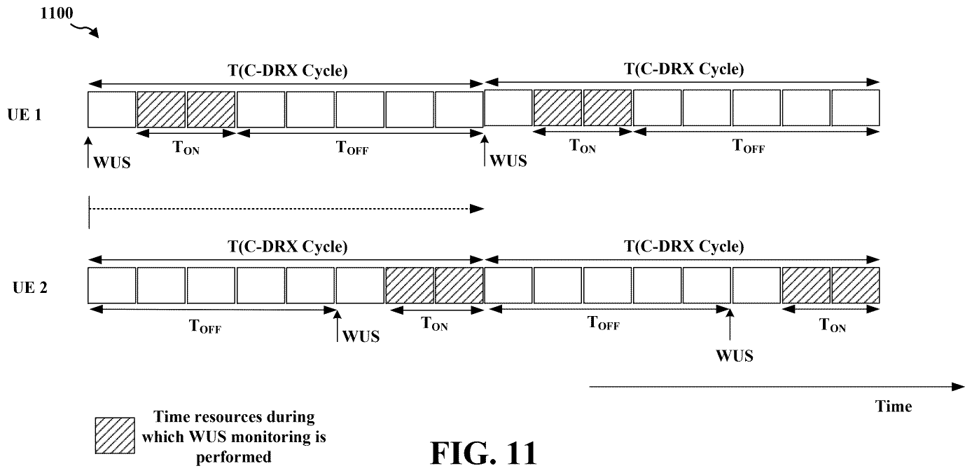

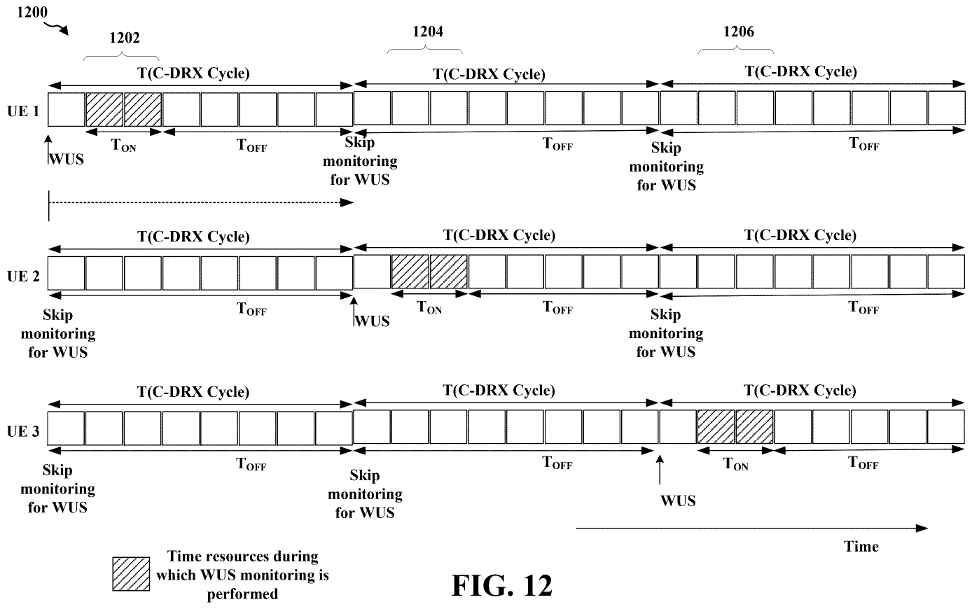

The network may have a knowledge of the collaboration of a group of UEs (e.g., collaboration between the UE 804 and the UE 801 in FIG. 8, for example, or between UE 1301 and UE 1304 in the communication flow 1300 in FIG. 13). FIG. 13 illustrates that a UE 1304 may transmit information to the base station 1302 informing the network of one or more aspects of the collaboration between the UE 1304 and the UE 1301. In some aspects, each UE in the collaborative UE group may provide collaboration information 1306 to the network. In some aspects, a representative UE for the group may provide the collaboration information 1306 to the network as a representative for the group. As illustrated at 1308 and 1310, the UE 1304 (e.g., UE 1) and the UE 1301 (e.g., UE 2) of the collaborative group may receive DRX configurations from the base station 1302. The UEs of the collaborative UE group may be configured with orthogonal DRX cycles, e.g., as shown in FIG. 11 and/or FIG. 12, for example.

The collaboration between UEs enables the base station to wake a UE within the group up more quickly if the base station misses an occasion to send a DCP/WUS for a particular UE (e.g., such as UE 2) because the base station can wake up UE 2 by sending a WUS to another UE in the collaborative group (e.g., such as UE 1 or UE 3 in FIG. 11 or FIG. 12). The WUS may indicate for the UE 2 to wake up, and the UE that received the WUS (e.g., UE 1 or UE 3) may send an indication to the UE 2 to wake up in response to reception of the WUS. In some aspects, the UE may be designated to monitor DCP/WUS for the group at that time. As shown, the UE 2 may skip monitoring for the WUS, in some aspects. For example, as illustrated in connection with FIG. 11 and/or FIG. 12, the UEs may take turns monitoring for a DCP or WUS. Taking turns monitoring for the DCP/WUS enables individual UEs to have a longer DRX OFF duration. For example, FIG. 13 illustrates the UE 1301 and the UE 1304 monitoring for DCP/WUS at different times, e.g., 1312, 1314, 1316, and 1318. In FIG. 11 and FIG. 12, when UE 1 is monitoring for DCP/WUS, UE 2 (and UE 3 in the example in FIG. 12) may skip monitoring for DCP/WUS (e.g., and rely on UE 1 to inform them if a DCP/WUS is received), which allows UE 2 and UE 3 to stay in the DRX OFF mode (e.g., a sleep mode or lower power mode) for a longer period of time. Similarly, when UE 2 monitors for DCP/WUS, the UE 1 (and UE 3 in FIG. 12) can skip monitoring and rely on UE 2 to inform them if a DCP/WUS is received.

FIG. 13 illustrates that UE 1304 receives a DCP/WUS, at 1320, that indicates for the UE 1301 to wake up. In response to reception of the DCP/WUS for the UE 1301, the UE 1304 transmits and indication to the UE 1301, at 1322. For example, if the UE 1304 receives a WUS intended for the UE 1301, the UE 1304 can relay information about the WUS (or the WUS itself) to the UE 1301, at 1322, via sidelink or any other local communication technology (e.g., which may include direct communication between the UEs without sending a transmission via the base station 1302). The UE 1301 may then wake up to monitor for PDCCH, at 1324, in order to receive the PDCCH transmission 1326, which may schedule additional communication 1328 between the UE 1301 and the base station 1302.

This coordination helps to reduce latency because the base station does not need to wait for a full DRX cycle completion to wake up the UE 1301, without increasing power consumption because each UE can follow its configured DRX cycle (e.g., without shortening the DRX cycle for individual UEs as at 1050 in FIG. 10).

In the example timeline 1100 in FIG. 11, the UE 1 and UE 2 have orthogonal ON durations. If the network misses the WUS occasion for UE 1, the network can send a WUS to the UE 2 indicating for the UE 1 to wake up. The UE 2 can then inform the UE 1 of the WUS. As the UEs are configured for orthogonal ON durations, the amount of time between WUS occasions is reduced while maintaining the same DRX cycle length. The UE 2 will receive WUS for UE1 from the network. In some aspects, the UE 2 may be a customer premises equipment (CPE), and the UE 1 may be another wireless device, such as a smartphone or a smartwatch, among other examples. As the CPE may be plugged into a power source rather than relying on battery power, the CPE may have less use for longer C-DRX cycles to achieve for power saving and longer battery life. Although two UEs are shown as an example to illustrate the concept. The concept may be applied to any group of two or more UEs in a collaborative group.

In some aspects, UEs can be configured with the same C-DRX cycle duration, yet may coordinate, negotiate, or agree to split the work (e.g., monitoring occasions) such that one UE is responsible for receiving WUS for other UEs (e.g., each of the other UEs in the collaborative group) in one cycle, and another UE does the same in other C-DRX cycles. FIG. 12 illustrates an example 1200 in which a UE in a collaborative group can stop monitoring for WUS and enter a longer C-DRX cycle duration for further power saving, without increasing latency for communication with the network.

The network may have knowledge of the collaboration group of UEs, e.g., as described in connection with FIG. 13. In some aspects, the network may assign a group-common PS-RNTI for the group of UEs to use in monitoring for the DCP/WUS at the common occasion (e.g., as described in connection with FIG. 7B). As an example, in FIG. 12, one or more of the occasions 1202, 1204, and/or 1206 may be occasions that are common to other DRX configurations and/or DCP configurations. The collaborating UEs (e.g., UE 1, UE 2, and UE 3) can agree on splitting the monitoring work between C-DRX cycles. For example, the UEs may coordinate (e.g., as shown at 1305) such that within a C-DRX cycle, UE 1 in the group monitors for WUS based on the group-common PS-RNTI in one C-DRX cycle, while UE 2 monitors for WUS in a subsequent C-DRX cycle, and UE 3 monitors for WUS in an additional subsequent C-DRX cycle.

The WUS transmitted by the base station may indicate which UE is to wake up. For example, the WUS may contain an indication about which specific UE is to wake up in response to the WUS. Alternatively, all of the UEs in the cooperative group may wake up in response to one WUS that is received by one UE in the group (and then indicated to the other UEs by that one UE).

Although three UEs are shown as an example to illustrate the concept. The concept may be applied to any group of two or more UEs in a collaborative group that may coordinate to take turns monitoring for WUS. For example, the concept can be extended to a group of N collaborating UEs, where N is a positive integer number. By coordinating a split of the monitoring work between the group of UEs, each UE is enabled to wake up to monitor for WUS every N C-DRX cycles and to remain in the reduced power mode for an extended OFF duration for N−1 cycles. Each UE may sleep (e.g., skip PDCCH monitoring) for longer time depending on the number of UEs collaborating. As a result, latency can be reduced by decreasing the duration of the C-DRX cycle and power consumption can be reduced through the coordination of WUS monitoring among the UEs of the collaborative UE group.

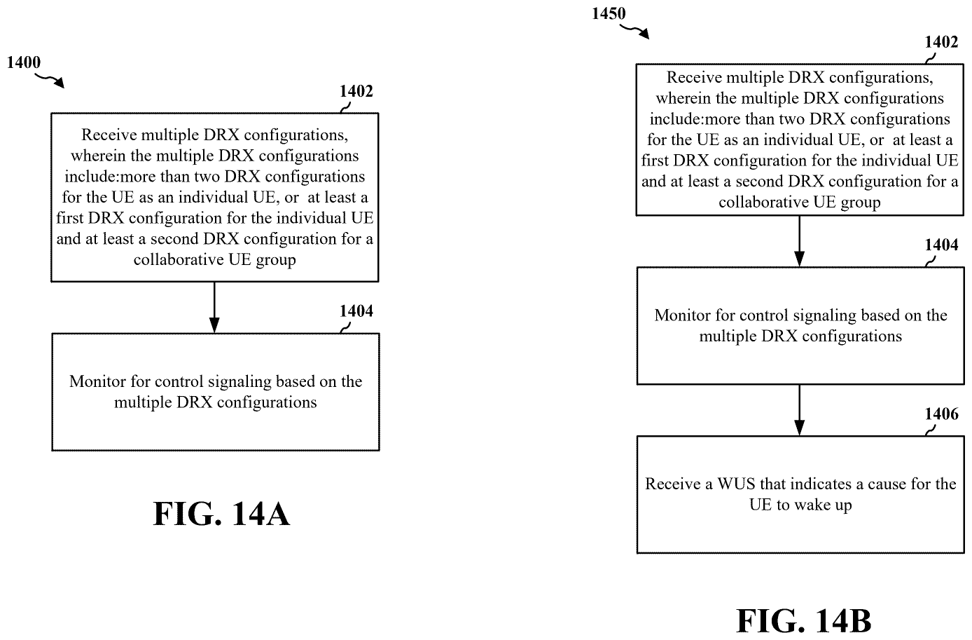

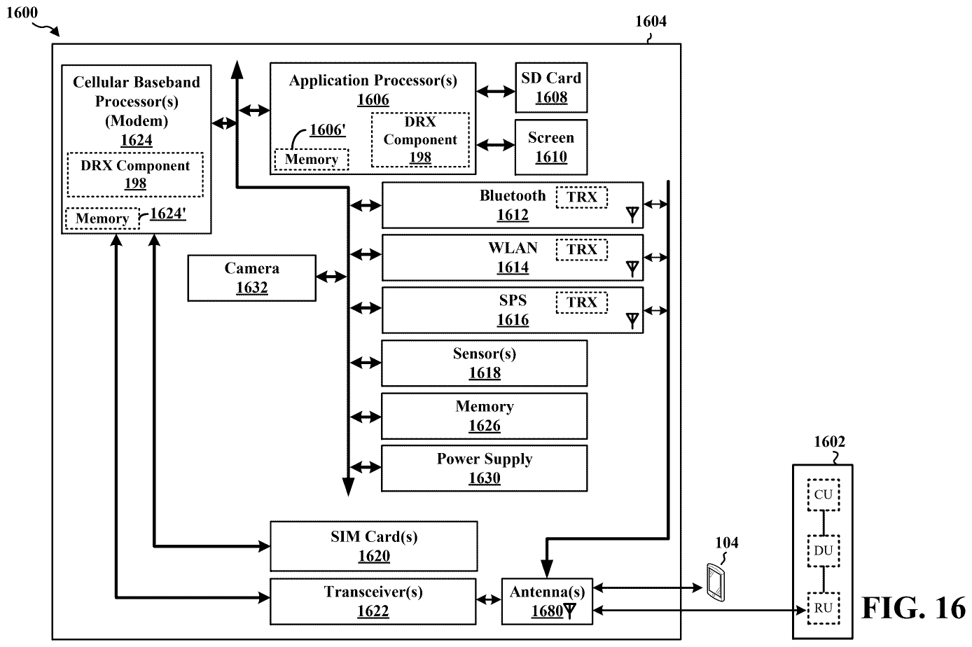

FIG. 14A is a flowchart 1400 of a method of wireless communication. The method may be performed by a UE (e.g., the UE 104, 204, 450, 604, 604a, 604b, 604c, 604d, 604e, 801, 804, 1301, 1304; the apparatus 1604). The method may include any of the aspects described in connection with the communication flow in FIG. 8 and/or FIG. 13, and/or described in connection with the flowchart in FIG. 16. The method may enable a UE to operate based on multiple DRX configurations in an accurate manner. The multiple DRX configurations may allow for increased power efficiency at the UE. In some aspects, the method may enable the UE to coordinate with other UEs to share the work of monitoring for signaling while in a DRX mode, which may reduce latency while maintaining or increasing power savings at the UE.

At 1402, the UE receives multiple discontinuous reception (DRX) configurations, wherein the multiple DRX configurations include: more than two DRX configurations for the UE as an individual UE, or at least a first DRX configuration for the individual UE and at least a second DRX configuration for a collaborative UE group. A collaborative group may include multiple UEs, e.g., two or more UEs, for example. For example, FIG. 8 and FIG. 13 illustrate examples of a UE receiving multiple DRX configurations. The multiple DRX configurations may include any of the aspects described in connection with any of FIGS. 5A-13, for example. FIGS. 6B and 6C illustrate example aspects of a collaborative UE group, which may also be referred to as virtual UEs. The reception of the multiple DRX configurations may be performed, e.g., by any combination of the DRX component 198, the transceiver(s) 1622, and/or the antenna(s) 1680. The UE may be in a connected mode, and the DRX configurations may be C-DRX configurations, as described herein.

In some aspects, one DRX configuration may be associated with multiple collaborative UE groups. In some aspects, different collaborative UE groups may have different DRX configurations. In some aspects, each DRX configuration may have an associated DCP configuration. In some aspects, a DCP configuration may be shared among multiple DRX configurations. In some aspects, the multiple DRX configurations may be within a maximum number of configurable S-DRX configurations, and the maximum number may be defined in a wireless standard and/or based on a UE capability of the UE or of UEs in a collaborative UE group.

At 1404, the UE monitors for control signaling based on the multiple DRX configurations. In some aspects, each DRX configuration of the multiple DRX configurations may have a corresponding RNTI. For example, multiple RNTIs can be assigned to a single UE for managing scheduling and DRX configurations of collaborative UE groups and/or an individual UE. The monitoring may be performed, e.g., by any combination of the DRX component 198, the transceiver(s) 1622, and/or the antenna(s) 1680. The monitoring for control signaling based on DRX configurations may include any of the aspects described in connection with FIGS. 5A-13, for example.

In some aspects, the UE may receive a WUS (e.g., which may be referred to as a DCP and which may be a DCI format 2_6 with wake up indication information) that indicates a cause for the UE to wake up, where the cause is associated with a DRX configuration of the multiple DRX configurations. For example, FIG. 14B illustrates an example flowchart 1450 in which the UE may further receive the WUS, at 1406, that indicates the cause. The reception may be performed, e.g., by any combination of the DRX component 198, the transceiver(s) 1622, and/or the antenna(s) 1680. In some examples, the cause may be indicated by one or more of: a RNTI for the WUS, a resource for the WUS, or information in a payload of the WUS. FIG. 7A-13 illustrate various aspects that may be used to indicate a cause associated with a WUS. Tables 2, 3, and 4, illustrate example aspects that may be used to indicate a cause for a WUS.

In some aspects, a wake up time for a DRX configuration of the multiple DRX configurations may be based on whether the DRX configuration is for the individual UE or the collaborative UE group. For example, FIG. 8 and FIG. 13 illustrate that it may take time for UEs in a collaborative UE group to coordinate after a WUS and to be ready to monitor for PDCCH. In some aspects, the wake up time for the collaborative UE group may be based on a shortest wake up time supported by UEs in the collaborative UE group or a longest wake up time supported by at least one UE in the collaborative UE group.

In some aspects, the UE may transmit (e.g., to the base station) a request for a wake up time offset. The transmission may be performed, e.g., by any combination of the DRX component 198, the transceiver(s) 1622, and/or the antenna(s) 1680. As an example, if there are multiple DRX configurations, the UE may request, or control, time alignment for the DRX configurations. In some aspects, the UE may indicate the preferred time offset to the base station, and one or more of the DRX configurations received at 1402 may be based on the preferred time offset. In some aspects, the UE may indicate a wake up time offset preference for itself as an individual UE. In some aspects, the UE may indicate a wake up time offset preference as a representative UE for a collaborative UE group. For example, the UE may receive time offset preference information from one or more UEs in the group and may transmit preference information to the base station for the group (e.g., based on the information received from the other UE(s) of the group). In some aspects, the wake up time offset aligns wake up times for the multiple DRX configurations.

In some aspects, the multiple DRX configurations may have a common wake up signal monitoring occasion with different time offsets. For example, FIG. 9 illustrates an example in which the monitoring occasion may be common, and different time offsets are provided for the UE as an individual and for a collaborative UE group.

In some aspects, the UE may be a first UE in the collaborative UE group, and the UE may receive a wake up signal for a second UE in the collaborative UE group and provide an indication of the wake up signal to the second UE. The reception and the providing may be performed, e.g., by any combination of the DRX component 198, the transceiver(s) 1622, and/or the antenna(s) 1680. For example, FIG. 13 illustrates an example in which the UE 1304 receives a WUS (e.g., 1320) that is to wake up the UE 1301. The UE 1304 then sends an indication of the WUS to the UE 1301 at 1322. In some aspects, the UE 1304 may send the indication in a sidelink transmission or other local communication technology (e.g., which may include direct communication between the UEs without sending a transmission via the base station 1302).

In some aspects, the UE is a second UE in the collaborative UE group, and the UE receives, from a first UE in the collaborative UE group, an indication of a wake up signal for the second UE. The reception may be performed, e.g., by any combination of the DRX component 198, the transceiver(s) 1622, and/or the antenna(s) 1680. For example, FIG. 13 illustrates the UE 1301 receiving the indication (e.g., 1322) of the WUS from the UE 1304.

In some aspects, the UE may agree to a shared monitoring schedule with the collaborative UE group, wherein the shared monitoring schedule schedules one or more UEs of the collaborative UE group to skip at least one monitoring occasion that is to be monitored by another UE of the collaborative UE group. The agreement (e.g., exchange of messages or negotiation) may be performed, e.g., by any combination of the DRX component 198, the transceiver(s) 1622, and/or the antenna(s) 1680. FIG. 13 illustrates that the UE 1304 and the UE 1301 may coordinate, at 1305, to share a monitoring schedule. FIG. 11 and FIG. 12 illustrate example aspects in which UEs in a collaborative UE group may perform coordinated DCP monitoring (e.g., WUS monitoring) to share the monitoring load. In some aspects, the UE may wake up to monitor one out of every N monitoring occasions, wherein N is an integer number based on a number of UEs in the collaborative UE group. To illustrate the concept, FIG. 12 illustrates an example of monitoring 1 out of every 3 monitoring occasions for a group of three UEs. The waking up may be performed, e.g., by any combination of the DRX component 198, the transceiver(s) 1622, and/or the antenna(s) 1680.

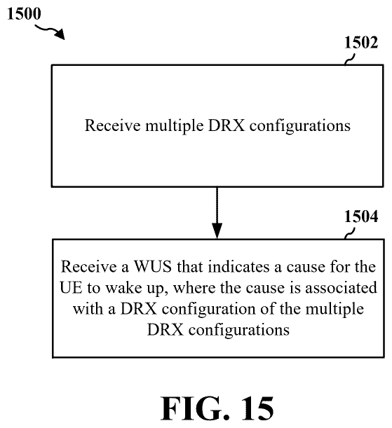

FIG. 15 is a flowchart 1500 of a method of wireless communication. The method may be performed by a UE (e.g., the UE 104, 204, 450, 604, 604a, 604b, 604c, 604d, 604e, 801, 804, 1301, 1304; the apparatus 1604). The method may include any of the aspects described in connection with the communication flow in FIG. 8 and/or FIG. 13, and/or described in connection with the flowchart in FIG. 14A or 14B. The method may enable a UE to operate based on one or more DRX configurations and to accurately determine whether to wake up. In some aspects, the method may enable the UE to coordinate with other UEs to share the work of monitoring for signaling while in a DRX mode, which may reduce latency while maintaining or increasing power savings at the UE.

At 1502, the UE receives multiple DRX configurations. For example, FIG. 8 and FIG. 13 illustrate examples of a UE receiving multiple DRX configurations. The multiple DRX configurations may include any of the aspects described in connection with any of FIGS. 5A-13, for example. The reception of the multiple DRX configurations may be performed, e.g., by any combination of the DRX component 198, the transceiver(s) 1622, and/or the antenna(s) 1680.

At 1504, the UE receives a WUS that indicates a cause for a UE to wake up, where the cause is associated with a DRX configuration of the multiple DRX configurations. In some examples, the cause may be indicated by one or more of: a RNTI for the WUS, a resource for the WUS, or information in a payload of the WUS. FIG. 7A-13 illustrate various aspects that may be used to indicate a cause associated with a WUS. Tables 2, 3, and 4, illustrate example aspects that may be used to indicate a cause for a WUS. The reception of the WUS may be performed, e.g., by any combination of the DRX component 198, the transceiver(s) 1622, and/or the antenna(s) 1680.

The UE may determine the cause from the WUS, and may determine whether to take further action based on the determined cause. For example, the UE may determine to wake up based on the determination that the WUS is for the UE to wake up, e.g., either as an individual UE or as part of a collaborative UE group. In some aspects, the UE may forward information about the WUS to one or more UEs based on a determination that the cause is for the other UE to wake up, e.g., as an individual UE, or for the other UEs in the collaborative group to wake up, e.g., as described in connection with FIGS. 11, 12, and/or 13.

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include at least one cellular baseband processor 1624 (also referred to as a modem) coupled to one or more transceivers 1622 (e.g., cellular RF transceiver). The cellular baseband processor(s) 1624 may include at least one on-chip memory 1624′. In some aspects, the apparatus 1604 may further include one or more subscriber identity modules (SIM) cards 1620 and at least one application processor 1606 coupled to a secure digital (SD) card 1608 and a screen 1610. The application processor(s) 1606 may include on-chip memory 1606′. In some aspects, the apparatus 1604 may further include a Bluetooth module 1612, a WLAN module 1614, an SPS module 1616 (e.g., GNSS module), one or more sensor modules 1618 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize the antennas 1680 for communication. The cellular baseband processor(s) 1624 communicates through the transceiver(s) 1622 via one or more antennas 1680 with the UE 104 and/or with an RU associated with a network entity 1602. The cellular baseband processor(s) 1624 and the application processor(s) 1606 may each include a computer-readable medium/memory 1624′, 1606′, respectively. The additional memory modules 1626 may also be considered a computer-readable medium/memory. Each computer-readable medium/memory 1624′, 1606′, 1626 may be non-transitory. The cellular baseband processor(s) 1624 and the application processor(s) 1606 are each responsible for general processing, including the execution of software stored on the computer-readable medium/memory. The software, when executed by the cellular baseband processor(s) 1624/application processor(s) 1606, causes the cellular baseband processor(s) 1624/application processor(s) 1606 to perform the various functions described supra. The cellular baseband processor(s) 1624 and the application processor(s) 1606 are configured to perform the various functions described supra based at least in part of the information stored in the memory. That is, the cellular baseband processor(s) 1624 and the application processor(s) 1606 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1624/application processor(s) 1606 when executing software. The cellular baseband processor(s) 1624/application processor(s) 1606 may be a component of the UE 450 and may include the at least one memory 460 and/or at least one of the TX processor 468, the RX processor 456, and the controller/processor 459. In one configuration, the apparatus 1604 may be at least one processor chip (modem and/or application) and include just the cellular baseband processor(s) 1624 and/or the application processor(s) 1606, and in another configuration, the apparatus 1604 may be the entire UE (e.g., see UE 450 of FIG. 4) and include the additional modules of the apparatus 1604.

As discussed supra, in some aspects, the DRX component 198 may be configured to receive multiple DRX configurations, wherein the multiple DRX configurations include: more than two DRX configurations for the UE as an individual UE, or at least a first DRX configuration for the individual UE and at least a second DRX configuration for a collaborative UE group; and monitor for control signaling based on the multiple DRX configurations. The DRX component 198 and/or another component of the apparatus 1604 may be further configured to receive a WUS that indicates a cause for the UE to wake up, wherein the cause is associated with a DRX configuration of the multiple DRX configurations. The DRX component 198 and/or another component of the apparatus 1604 may be further configured to transmit a request for a wake up time offset. In some aspects, the apparatus may be for a UE that is a first UE in the collaborative UE group, and the DRX component 198 and/or another component of the apparatus 1604 may be further configured to receive a wake up signal for a second UE in the collaborative UE group; and provide an indication of the wake up signal to the second UE. In some aspects, the apparatus may be for a UE that is a second UE in the collaborative UE group, and the DRX component 198 and/or another component of the apparatus 1604 may be further configured to receive, from a first UE in the collaborative UE group, an indication of a wake up signal for the second UE. The DRX component 198 and/or another component of the apparatus 1604 may be further configured to agree to a shared monitoring schedule with the collaborative UE group, wherein the shared monitoring schedule schedules one or more UEs of the collaborative UE group to skip at least one monitoring occasion that is to be monitored by another UE of the collaborative UE group. The DRX component 198 and/or another component of the apparatus 1604 may be further configured to wake up to monitor one out of every N monitoring occasions, wherein N is an integer number based on a number of UEs in the collaborative UE group. The DRX component 198 and/or another component of the apparatus 1604 may be further configured to receive multiple DRX configurations; and receive a WUS that indicates a cause for the UE to wake up, wherein the cause is associated with a DRX configuration of the multiple DRX configurations. The DRX component 198 and/or another component of the apparatus 1604 may be further configured to perform any of the aspects described in connection with the flowchart in any of FIGS. 14A, 14B, and/or 15, and/or any of the aspects performed by a UE in the communication flow of FIG. 8 and/or FIG. 13. The DRX component 198 may be within the cellular baseband processor(s) 1624, the application processor(s) 1606, or both the cellular baseband processor(s) 1624 and the application processor(s) 1606. The DRX component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination.

As shown, the apparatus 1604 may include a variety of components configured for various functions. In one configuration, the apparatus 1604, and in particular the cellular baseband processor(s) 1624 and/or the application processor(s) 1606, may include means for receiving multiple discontinuous reception (DRX) configurations, wherein the multiple DRX configurations include: more than two DRX configurations for the UE as an individual UE, or at least a first DRX configuration for the individual UE and at least a second DRX configuration for a collaborative UE group; and means for monitoring for control signaling based on the multiple DRX configurations. The apparatus 1604 may further include means for The apparatus 1604 may further include means for receiving a wake up signal (WUS) that indicates a cause for the UE to wake up, wherein the cause is associated with a DRX configuration of the multiple DRX configurations. The apparatus 1604 may further include means for transmitting a request for a wake up time offset. In some aspects, the apparatus may be for a UE that is a first UE in the collaborative UE group, and the apparatus 1604 may further include means for receiving a wake up signal for a second UE in the collaborative UE group; and means for providing an indication of the wake up signal to the second UE. In some aspects, the apparatus may be for a UE that is a second UE in the collaborative UE group, and the apparatus 1604 may further include means for receiving, from a first UE in the collaborative UE group, an indication of a wake up signal for the second UE. The apparatus 1604 may further include means for agreeing to a shared monitoring schedule with the collaborative UE group, wherein the shared monitoring schedule schedules one or more UEs of the collaborative UE group to skip at least one monitoring occasion that is to be monitored by another UE of the collaborative UE group. The apparatus 1604 may further include means for waking up to monitor one out of every N monitoring occasions, wherein N is an integer number based on a number of UEs in the collaborative UE group. In some aspects the apparatus 1604 may include means for receiving multiple DRX configurations; and means for receiving a WUS that indicates a cause for the UE to wake up, wherein the cause is associated with a DRX configuration of the multiple DRX configurations. The apparatus 1604 may further include means for performing any of the aspects described in connection with the flowchart in any of FIGS. 14A, 14B, and/or 15, and/or any of the aspects performed by a UE in the communication flow of FIG. 8 and/or FIG. 13. The means may be the DRX component 198 of the apparatus 1604 configured to perform the functions recited by the means. As described supra, the apparatus 1604 may include the TX processor 468, the RX processor 456, and the controller/processor 459. As such, in one configuration, the means may be the TX processor 468, the RX processor 456, and/or the controller/processor 459 configured to perform the functions recited by the means.

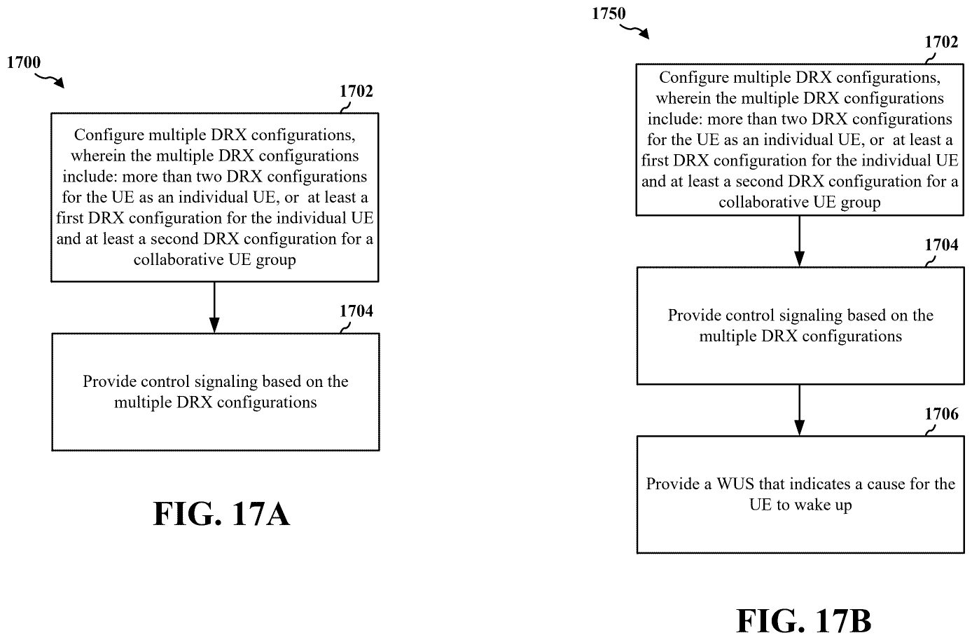

FIG. 17A is a flowchart 1700 of a method of wireless communication. The method may be performed by a network node, which may include one or more components of a base station (e.g., the base station 102, 202, 410, 602, 802, 1302; the network entity 1902; the CU 106, 210; the DU 105, 230; and/or the RU 109, 240). The method may include any of the aspects described in connection with the communication flow in FIG. 8 and/or FIG. 13, and/or described in connection with the flowchart in FIG. 17A or 17B. The method may enable a network node to configure a UE to operate based on one or more DRX configurations and to provide information that enables the UE accurately determine whether to wake up. In some aspects, the method may allow the network node to enable the UE to coordinate with other UEs to share the work of monitoring for signaling while in a DRX mode, which may reduce latency while maintaining or increasing power savings at the UE.

At 1702, the network node configures multiple DRX configurations for a UE, wherein the multiple DRX configurations include: more than two DRX configurations for the UE as an individual UE, or at least a first DRX configuration for the individual UE and at least a second DRX configuration for a collaborative UE group. For example, FIG. 8 and FIG. 13 illustrate examples of a network node configuring multiple DRX configurations. The multiple DRX configurations may include any of the aspects described in connection with any of FIGS. 5A-13, for example. FIGS. 6B and 6C illustrate example aspects of a collaborative UE group, which may also be referred to as virtual UEs. The configuration of the multiple DRX configurations may be performed, e.g., by any combination of the DRX component 199, the transceiver(s) 1946, and/or the antenna(s) 1980. The network node may be in an RRC connected mode with the UE, and the DRX configurations may be C-DRX configurations, as described herein.

In some aspects, one DRX configuration may be associated with multiple collaborative UE groups. In some aspects, different collaborative UE groups may have different DRX configurations. In some aspects, each DRX configuration may have an associated DCP configuration. In some aspects, a DCP configuration may be shared among multiple DRX configurations. In some aspects, the multiple DRX configurations may be within a maximum number of configurable S-DRX configurations, and the maximum number may be defined in a wireless standard and/or based on a UE capability received from the UE or received from UEs in a collaborative UE group with the UE.

At 1704, the network node provides control signaling based on the multiple DRX configurations. In some aspects, each DRX configuration of the multiple DRX configurations may have a corresponding RNTI. For example, multiple RNTIs can be assigned to a single UE for managing scheduling and DRX configurations of collaborative UE groups and/or an individual UE. The providing may be performed, e.g., by any combination of the DRX component 199, the transceiver(s) 1946, and/or the antenna(s) 1980.

In some aspects, the network node may provide a WUS (e.g., which may be referred to as a DCP and which may be a DCI format 2_6 with wake up indication information) that indicates a cause for the UE to wake up, where the cause is associated with a DRX configuration of the multiple DRX configurations. For example, FIG. 17B illustrates an example flowchart 1750 in which the network node may further provide the WUS that indicates a cause for the UE to wake up, at 1706. The cause may be associated with a DRX configuration of the multiple DRX configurations, for example. The providing may be performed, e.g., by any combination of the DRX component 199, the transceiver(s) 1946, and/or the antenna(s) 1980. In some examples, the cause may be indicated by one or more of: a RNTI for the WUS, a resource for the WUS, or information in a payload of the WUS. FIG. 7A-13 illustrate various aspects that may be used to indicate a cause associated with a WUS. Tables 2, 3, and 4, illustrate example aspects that may be used to indicate a cause for a WUS.

In some aspects, a wake up time for a DRX configuration of the multiple DRX configurations may be based on whether the DRX configuration is for the individual UE or the collaborative UE group. For example, FIG. 8 and FIG. 13 illustrate that it may take time for UEs in a collaborative UE group to coordinate after a WUS and to be ready to monitor for PDCCH. As an example, the network node may receive wake up time information for each UE in the collaborative UE group, and the wake up time for the collaborative UE group may be based on a shortest wake up time supported by UEs in the collaborative UE group or a longest wake up time supported by at least one UE in the collaborative UE group. The reception may be performed, e.g., by any combination of the DRX component 199, the transceiver(s) 1946, and/or the antenna(s) 1980.

In some aspects, the network node may receive a request for a wake up time offset for the UE, wherein the wake up time offset aligns wake up times for the multiple DRX configurations. The reception may be performed, e.g., by any combination of the DRX component 199, the transceiver(s) 1946, and/or the antenna(s) 1980. As an example, if there are multiple DRX configurations, the network node may receive a request for time alignment for the DRX configurations. In some aspects, the request may indicate the preferred time offset to the base station, and one or more of the DRX configurations configured at 1702 may be based on the preferred time offset. In some aspects, the request may indicate a wake up time offset preference for an individual UE. In some aspects, the request may indicate a wake up time offset preference from a representative UE for a collaborative UE group. In some aspects, the wake up time offset aligns wake up times for the multiple DRX configurations.

In some aspects, the multiple DRX configurations may have a common wake up signal monitoring occasion with different time offsets. For example, FIG. 9 illustrates an example in which the monitoring occasion may be common, and different time offsets are provided for the UE as an individual and for a collaborative UE group.

In some aspects, the network node may provide a wake up signal for a second UE in the collaborative UE group during a monitoring occasion for a first UE in the collaborative UE group. The providing may be performed, e.g., by any combination of the DRX component 199, the transceiver(s) 1946, and/or the antenna(s) 1980. For example, FIG. 13 illustrates an example in which the network node provides a WUS (e.g., 1320) to wake up the UE 1301 during a monitoring occasion of the UE 1304.

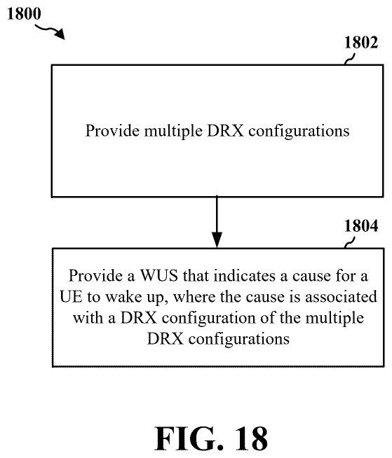

FIG. 18 is a flowchart 1800 of a method of wireless communication. The method may be performed by a network node, which may include one or more components of a base station (e.g., the base station 102, 202, 410, 602, 802, 1302; the network entity 1902; the CU 106, 210; the DU 105, 230; and/or the RU 109, 240). The method may include any of the aspects described in connection with the communication flow in FIG. 8 and/or FIG. 13, and/or described in connection with the flowchart in FIG. 17A or 17B. The method may enable a network node to configure a UE to operate based on one or more DRX configurations and to provide information that enables the UE accurately determine whether to wake up. In some aspects, the method may allow the network node to enable the UE to coordinate with other UEs to share the work of monitoring for signaling while in a DRX mode, which may reduce latency while maintaining or increasing power savings at the UE.

At 1802, the network node provides multiple DRX configurations. For example, FIG. 8 and FIG. 13 illustrate examples of a network node providing multiple DRX configurations. The multiple DRX configurations may include any of the aspects described in connection with any of FIGS. 5A-13, for example. The providing of the multiple DRX configurations may be performed, e.g., by any combination of the DRX component 199, the transceiver(s) 1946, and/or the antenna(s) 1980.

At 1804, the network node provides a WUS that indicates a cause for a UE to wake up, where the cause is associated with a DRX configuration of the multiple DRX configurations. In some examples, the cause may be indicated by one or more of: a RNTI for the WUS, a resource for the WUS, or information in a payload of the WUS. FIG. 7A-13 illustrate various aspects that may be used to indicate a cause associated with a WUS. Tables 2, 3, and 4, illustrate example aspects that may be used to indicate a cause for a WUS. The indication of the cause may be performed, e.g., by any combination of the DRX component 199, the transceiver(s) 1946, and/or the antenna(s) 1980. In some aspects, the cause may be for an individual UE to wake up in connection with a particular DRX configuration. In some aspects, the cause may be for a different individual UE to wake up. In some aspects, the cause may be for a collaborative UE group to wake up.

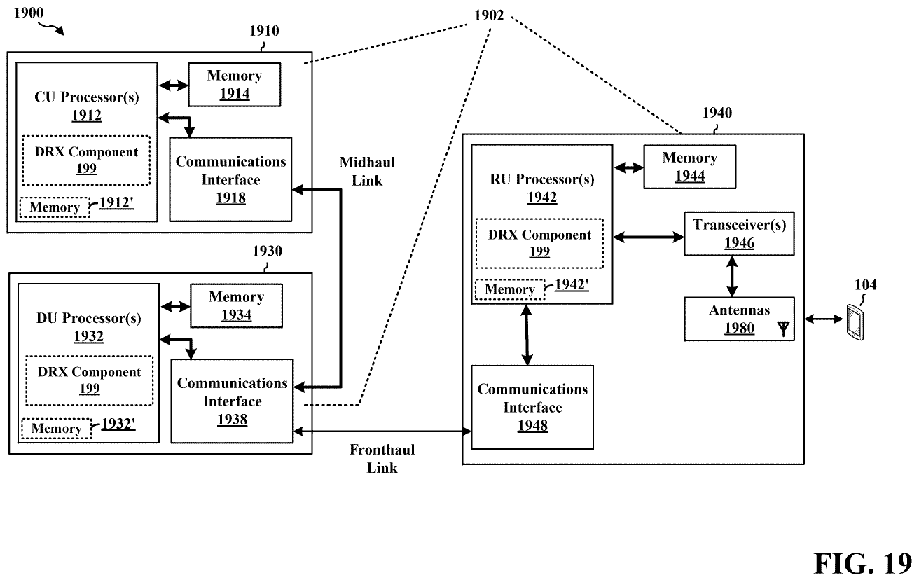

FIG. 19 is a diagram 1900 illustrating an example of a hardware implementation for a network entity 1902. The network entity 1902 may be a BS, a component of a BS, or may implement BS functionality. The network entity 1902 may include at least one of a CU 1910, a DU 1930, or an RU 1940. For example, depending on the layer functionality handled by the DRX component 199, the network entity 1902 may include the CU 1910; both the CU 1910 and the DU 1930; each of the CU 1910, the DU 1930, and the RU 1940; the DU 1930; both the DU 1930 and the RU 1940; or the RU 1940. The CU 1910 may include at least one CU processor 1912. The CU processor(s) 1912 may include on-chip memory 1912′. In some aspects, the CU 1910 may further include additional memory modules 1914 and a communications interface 1918. The CU 1910 communicates with the DU 1930 through a midhaul link, such as an F1 interface. The DU 1930 may include at least one DU processor 1932. The DU processor(s) 1932 may include on-chip memory 1932′. In some aspects, the DU 1930 may further include additional memory modules 1934 and a communications interface 1938. The DU 1930 communicates with the RU 1940 through a fronthaul link. The RU 1940 may include at least one RU processor 1942. The RU processor(s) 1942 may include on-chip memory 1942′. In some aspects, the RU 1940 may further include additional memory modules 1944, one or more transceivers 1946, antennas 1980, and a communications interface 1948. The RU 1940 communicates with the UE 104. The on-chip memory 1912′, 1932′, 1942′ and the additional memory modules 1914, 1934, 1944 may each be considered a computer-readable medium/memory. Each computer-readable medium/memory may be non-transitory. Each of the processors 1912, 1932, 1942 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the DRX component 199 may be configured to configure multiple DRX configurations for a UE, wherein the multiple DRX configurations include: more than two DRX configurations for the UE as an individual UE, or at least a first DRX configuration for the UE as the individual UE and at least a second DRX configuration for a collaborative UE group; and provide control signaling for the UE based on the multiple DRX configurations. The DRX component 199 and/or the network entity 1902 may be further configured to provide a WUS that indicates a cause for the UE to wake up, wherein the cause is associated with a DRX configuration of the multiple DRX configurations, and wherein the cause is indicated by one or more of: a RNTI for the WUS, a resource for the WUS, or information in a payload of the WUS. The DRX component 199 and/or the network entity 1902 may be further configured to receive wake up time information for each UE in the collaborative UE group, wherein the wake up time for the collaborative UE group is based on a shortest wake up time supported by UEs in the collaborative UE group or a longest wake up time supported by at least one UE in the collaborative UE group. The DRX component 199 and/or the network entity 1902 may be further configured to receive a request for a wake up time offset for the UE, wherein the wake up time offset aligns wake up times for the multiple DRX configurations. The DRX component 199 and/or the network entity 1902 may be further configured to provide a wake up signal for a second UE in the collaborative UE group during a monitoring occasion for a first UE in the collaborative UE group. The DRX component 199 and/or the network entity 1902 may be configured to provide multiple DRX configurations; and provide a WUS that indicates a cause for a UE to wake up, wherein the cause is associated with a DRX configuration of the multiple DRX configurations. The DRX component 199 and/or another component of the network entity 1902 may be further configured to perform any of the aspects described in connection with the flowchart in any of FIGS. 17A, 17B, and/or 18, and/or any of the aspects performed by the base station in the communication flow of FIG. 8 and/or FIG. 13. The DRX component 199 may be within one or more processors of one or more of the CU 1910, DU 1930, and the RU 1940. The DRX component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1902 may include a variety of components configured for various functions. In one configuration, the network entity 1902 may include means for configuring multiple DRX configurations for a UE, wherein the multiple DRX configurations include: more than two DRX configurations for the UE as an individual UE, or at least a first DRX configuration for the UE as the individual UE and at least a second DRX configuration for a collaborative UE group; and means for providing control signaling for the UE based on the multiple DRX configurations. The network entity 1902 may further include means for providing a WUS that indicates a cause for the UE to wake up, wherein the cause is associated with a DRX configuration of the multiple DRX configurations, and wherein the cause is indicated by one or more of: a RNTI for the WUS, a resource for the WUS, or information in a payload of the WUS. The network entity 1902 may further include means for receiving wake up time information for each UE in the collaborative UE group, wherein the wake up time for the collaborative UE group is based on a shortest wake up time supported by UEs in the collaborative UE group or a longest wake up time supported by at least one UE in the collaborative UE group. The network entity 1902 may further include means for receiving a request for a wake up time offset for the UE, wherein the wake up time offset aligns wake up times for the multiple DRX configurations. The network entity 1902 may further include means for providing a wake up signal for a second UE in the collaborative UE group during a monitoring occasion for a first UE in the collaborative UE group. The network entity 1902 may include means for providing multiple DRX configurations; and means for providing a WUS that indicates a cause for a UE to wake up, wherein the cause is associated with a DRX configuration of the multiple DRX configurations. The network entity may further include means for performing any of the aspects described in connection with the flowchart in any of FIGS. 17A, 17B, and/or 18, and/or any of the aspects performed by the base station in the communication flow of FIG. 8 and/or FIG. 13. The means may be the DRX component 199 of the network entity 1902 configured to perform the functions recited by the means. As described supra, the network entity 1902 may include the TX processor 416, the RX processor 470, and the controller/processor 475. As such, in one configuration, the means may be the TX processor 416, the RX processor 470, and/or the controller/processor 475 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S S F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” or “based on or otherwise in association with” unless specifically recited differently. As used herein, the phrase “associated with” encompasses any association, relation, or connection link. Among other examples, the phrase “associated with” may include in association with, based on, based at least in part on, corresponding to, related to, in response to, linked with, and/or connected with. As used herein, “using” may include any use, which may include any consideration, any calculation, and/or any dependency, among examples of use.

The following aspects are illustrative only and may be combined with other aspects or teachings described herein, without limitation.

Aspect 1 is a method of wireless communication at a user equipment (UE), comprising: receiving multiple discontinuous reception (DRX) configurations, wherein the multiple DRX configurations include: more than two DRX configurations for the UE as an individual UE, or at least a first DRX configuration for the individual UE and at least a second DRX configuration for a collaborative UE group; and monitoring for control signaling based on the multiple DRX configurations.

In aspect 2, the method of aspect 1 further includes that the multiple DRX configurations include more than two DRX configurations for the UE as an individual UE, or at least a first DRX configuration for the individual UE.

In aspect 3, the method of aspect 1 further includes that the multiple DRX configuration include at least a first DRX configuration for the individual UE and at least a second DRX configuration for a collaborative UE group.

In aspect 4, the method of aspect 1 further includes that the multiple DRX configuration include multiple DRX configurations for the individual UE and at least a second DRX configuration for a collaborative UE group.

In aspect 5, the method of aspect 1 further includes that the multiple DRX configuration include at least a first DRX configuration for the individual UE and multiple DRX configurations for a collaborative UE group.

In aspect 6, the method of aspect 1 further includes that the multiple DRX configuration include multiple DRX configurations for the individual UE and multiple DRX configurations for a collaborative UE group.

In aspect 7, the method of any of aspects 1-6 further includes that each DRX configuration of the multiple DRX configurations has a corresponding radio network temporary identifier (RNTI).

In aspect 8, the method of any of aspects 1-7 further includes receiving a wake-up signal (WUS) that indicates a cause for the UE to wake-up, wherein the cause is associated with a DRX configuration of the multiple DRX configurations.

In aspect 9, the method of aspect 8 further includes that the cause is indicated by one or more of: a radio network temporary identifier (RNTI) for the WUS, a resource for the WUS, or information in a payload of the WUS.

In aspect 10, the method of aspect 8 further includes that the cause is indicated by a radio network temporary identifier (RNTI) for the WUS.

In aspect 11, the method of aspect 8 further includes that the cause is indicated by a resource for the WUS.

In aspect 12, the method of aspect 8 further includes that the cause is indicated by information in a payload of the WUS.

In aspect 13, the method of any of aspects 1-12 further includes that a wake up time for a DRX configuration of the multiple DRX configurations is based on whether the DRX configuration is for the individual UE or the collaborative UE group.

In aspect 14, the method of aspect 13 further includes that the wake up time for the collaborative UE group is based on a shortest wake up time supported by UEs in the collaborative UE group or a longest wake up time supported by at least one UE in the collaborative UE group.

In aspect 15, the method of any of aspects 1-14 further includes transmitting a request for a wake up time offset.

In aspect 16, the method of aspect 15 further includes that the wake up time offset aligns wake up times for the multiple DRX configurations.

In aspect 17, the method of any of aspects 1-9, 15 or 16 further includes that the multiple DRX configurations have a common wake up signal monitoring occasion with different time offsets.

In aspect 18, the method of any of aspects 1-17 further includes that the UE is a first UE in the collaborative UE group, the method further comprising: receiving a wake up signal for a second UE in the collaborative UE group; and providing an indication of the wake up signal to the second UE.

In aspect 19, the method of any of aspects 1-17 further includes that the UE is a second UE in the collaborative UE group, the method further comprising: receiving, from a first UE in the collaborative UE group, an indication of a wake up signal for the second UE.

In aspect 20, the method of any of aspects 1-19 further includes agreeing to a shared monitoring schedule with the collaborative UE group, wherein the shared monitoring schedule schedules one or more UEs of the collaborative UE group to skip at least one monitoring occasion that is to be monitored by another UE of the collaborative UE group.

In aspect 21, the method of aspect 20 further includes waking up to monitor one out of every N monitoring occasions, wherein N is an integer number based on a number of UEs in the collaborative UE group.

Aspect 22 is a method of wireless communication at a user equipment (UE), comprising: receiving multiple discontinuous reception (DRX) configurations; and receiving a wake-up signal (WUS) that indicates a cause for the UE to wake-up, wherein the cause is associated with a DRX configuration of the multiple DRX configurations.

In aspect 23, the method of aspect 22 further includes that the cause is indicated by one or more of: a radio network temporary identifier (RNTI) for the WUS, a resource for the WUS, or information in a payload of the WUS.

In aspect 24, the method of aspect 22 further includes that the cause is indicated by a radio network temporary identifier (RNTI) for the WUS.

In aspect 25, the method of aspect 22 or 24 further includes that the cause is indicated by a resource for the WUS.

In aspect 26, the method of aspect 22, 24, or 25 further includes that the cause is indicated by information in a payload of the WUS.

Aspect 27 is a method of wireless communication at a network node, comprising: configuring multiple discontinuous reception (DRX) configurations for a user equipment (UE), wherein the multiple DRX configurations include: more than two DRX configurations for the UE as an individual UE, or at least a first DRX configuration for the UE as the individual UE and at least a second DRX configuration for a collaborative UE group; and providing control signaling for the UE based on the multiple DRX configurations.

In aspect 27, the method of aspect 26 further includes that the multiple DRX configurations include more than two DRX configurations for the UE as an individual UE, or at least a first DRX configuration for the individual UE.

In aspect 28, the method of aspect 26 further includes that the multiple DRX configuration include at least a first DRX configuration for the individual UE and at least a second DRX configuration for a collaborative UE group.

In aspect 29, the method of aspect 26 further includes that the multiple DRX configuration include multiple DRX configurations for the individual UE and at least a second DRX configuration for a collaborative UE group.

In aspect 30, the method of aspect 26 further includes that the multiple DRX configuration include at least a first DRX configuration for the individual UE and multiple DRX configurations for a collaborative UE group.

In aspect 31, the method of aspect 26 further includes that the multiple DRX configuration include multiple DRX configurations for the individual UE and multiple DRX configurations for a collaborative UE group.

In aspect 32, the method of any of aspects 27-31 further includes that each DRX configuration of the multiple DRX configurations has a corresponding radio network temporary identifier (RNTI).

In aspect 33, the method of any of aspects 27-32 further includes receiving a wake-up signal (WUS) that indicates a cause for the UE to wake-up, wherein the cause is associated with a DRX configuration of the multiple DRX configurations.

In aspect 34, the method of aspect 33 further includes that the cause is indicated by one or more of: a radio network temporary identifier (RNTI) for the WUS, a resource for the WUS, or information in a payload of the WUS.

In aspect 35, the method of aspect 33 further includes that the cause is indicated by a radio network temporary identifier (RNTI) for the WUS.

Aspect 36, the method of aspect 33 further includes that the cause is indicated by a resource for the WUS.

In aspect 37, the method of aspect 33 further includes that the cause is indicated by information in a payload of the WUS.

In aspect 38, the method of any of aspects 27-37 further includes that a wake up time for a DRX configuration is based whether the DRX configuration is for the individual UE or the collaborative UE group.

In aspect 39, the method of aspect 38 further includes receiving wake up time information for each UE in the collaborative UE group, wherein the wake up time for the collaborative UE group is based on a shortest wake up time supported by UEs in the collaborative UE group or a longest wake up time supported by at least one UE in the collaborative UE group.

In aspect 40, the method of any of aspects 27-39 further includes receiving a request for a wake up time offset for the UE, wherein the wake up time offset aligns wake up times for the multiple DRX configurations.

In aspect 41, the method of any of aspects 27-37 further includes that the multiple DRX configurations have a common wake up signal monitoring occasion with different time offsets.

In aspect 42, the method of any of aspects 27-41 further includes providing a wake up signal for a second UE in the collaborative UE group during a monitoring occasion for a first UE in the collaborative UE group.

Aspect 43 is a method of wireless communication at a network node, comprising: providing multiple discontinuous reception (DRX) configurations; and providing a wake-up signal (WUS) that indicates a cause for a user equipment (UE) to wake-up, wherein the cause is associated with a DRX configuration of the multiple DRX configurations.

In aspect 44, the method of aspect 43 further includes that the cause is indicated by one or more of: a radio network temporary identifier (RNTI) for the WUS, a resource for the WUS, or information in a payload of the WUS.

In aspect 45, the method of aspect 43 further includes that the cause is indicated by a radio network temporary identifier (RNTI) for the WUS.

In aspect 46, the method of aspect 43 further includes that the cause is indicated by a resource for the WUS.

In aspect 47, the method of aspect 43 further includes that the cause is indicated by information in a payload of the WUS.

Aspect 48 is an apparatus for wireless communication at a UE, comprising: one or more memories; and one or more processors coupled to the one or more memories and configured to cause the UE to perform the method of any of aspects 1-26.

Aspect 49 is an apparatus for wireless communication at a UE, comprising: one or more memories; and one or more processors coupled to the one or more memories and configured, individually or in any combination, to cause the UE to perform the method of any of aspects 1-26.

Aspect 50 is an apparatus for wireless communication at a UE, comprising means for performing each step in the method of any of aspects 1-26.

Aspect 51 is an apparatus for wireless communication at a UE comprising: a processing system that includes processor circuitry and memory circuitry that stores code and is coupled with the processor circuitry, the processing system configured to cause the UE to: perform the method of any of aspects 1-26.

In aspect 52, the apparatus of any of aspects 48-51 further includes one or more antennas coupled to the one or more processors, wherein transmission or reception of the method is performed via the one or more transceivers.

In aspect 53, the apparatus of any of aspects 48-52 further includes one or more transceivers couple to the one or more processors, wherein transmission or reception of the method is performed via the one or more transceivers.

Aspect 54 is a computer-readable storage medium (e.g., a non-transitory computer-readable storage medium) storing computer executable code for wireless communication at a UE, the code when executed by one or more processors causes the service to perform the method of any of aspects 1-26.

Aspect 55 is an apparatus for wireless communication at a network node, comprising: one or more memories; and one or more processors coupled to the one or more memories and configured to cause the network node to perform the method of any of aspects 27-47.

Aspect 56 is an apparatus for wireless communication at a network node, comprising: one or more memories; and one or more processors coupled to the one or more memories and configured, individually or in any combination, to cause the network node to perform the method of any of aspects 27-47.

Aspect 57 is an apparatus for wireless communication at a network node, comprising means for performing each step in the method of any of aspects 27-47.

Aspect 58 is an apparatus for wireless communication at a network node comprising: a processing system that includes processor circuitry and memory circuitry that stores code and is coupled with the processor circuitry, the processing system configured to cause the network node to: perform the method of any of aspects 27-47.

In aspect 59, the apparatus of any of aspects 55-58 further includes one or more antennas coupled to the one or more processors, wherein transmission or reception of the method is performed via the one or more antennas.

In aspect 60, the apparatus of any of aspects 55-59 further includes one or more transceivers couple to the one or more processors, wherein transmission or reception of the method is performed via the one or more transceivers.

Aspect 61 is a computer-readable storage medium (e.g., a non-transitory computer-readable storage medium) storing computer executable code for wireless communication at a network node, the code when executed by one or more processors causes the service to perform the method of any of aspects 27-47.

What is claimed is:

1. An apparatus for wireless communication at a user equipment (UE), comprising:
one or more memories; and
one or more processors coupled to the one or more memories and configured to cause the UE to:
receive multiple discontinuous reception (DRX) configurations, wherein the multiple DRX configurations include:
more than two DRX configurations for the UE as an individual UE, or
at least a first DRX configuration for the individual UE and at least a second DRX configuration for a collaborative UE group; and
monitor for a control signal based on the multiple DRX configurations.

2. The apparatus of claim 1, wherein each DRX configuration of the multiple DRX configurations has a corresponding radio network temporary identifier (RNTI).

3. The apparatus of claim 1, wherein the one or more processors are further configured to cause the UE to:
receive a wake up signal (WUS) that indicates a cause for the UE to wake up, wherein the cause is associated with a DRX configuration of the multiple DRX configurations.

4. The apparatus of claim 3, wherein the cause is indicated by one or more of:
a radio network temporary identifier (RNTI) for the WUS,
a resource for the WUS, or
information in a payload of the WUS.

5. The apparatus of claim 1, wherein a wake up time for a DRX configuration of the multiple DRX configurations is based on whether the DRX configuration is for the individual UE or the collaborative UE group.

6. The apparatus of claim 5, wherein the wake up time for the collaborative UE group is based on a shortest wake up time supported by UEs in the collaborative UE group or a longest wake up time supported by at least one UE in the collaborative UE group.

7. The apparatus of claim 1, wherein the one or more processors are further configured to cause the UE to:
transmit a request for a wake up time offset.

8. The apparatus of claim 7, wherein the wake up time offset aligns wake up times for the multiple DRX configurations.

9. The apparatus of claim 1, wherein the multiple DRX configurations have a common wake up signal monitoring occasion with different time offsets.

10. The apparatus of claim 1, wherein the UE is a first UE in the collaborative UE group, and wherein the one or more processors are further configured to cause the UE to:
receive a wake up signal for a second UE in the collaborative UE group; and
provide an indication of the wake up signal to the second UE.

11. The apparatus of claim 1, wherein the UE is a second UE in the collaborative UE group, and wherein the one or more processors are further configured to cause the UE to:
receive, from a first UE in the collaborative UE group, an indication of a wake up signal for the second UE.

12. The apparatus of claim 1, wherein the one or more processors are further configured to cause the UE to:
agree to a shared monitoring schedule with the collaborative UE group, wherein the shared monitoring schedule schedules one or more UEs of the collaborative UE group to skip at least one monitoring occasion that is to be monitored by another UE of the collaborative UE group.

13. The apparatus of claim 12, wherein the one or more processors are further configured to cause the UE to:
wake up to monitor one out of every N monitoring occasions, wherein N is an integer number based on a number of UEs in the collaborative UE group.

14. An apparatus for wireless communication at a network node, comprising:
one or more memories; and
one or more processors coupled to the one or more memories and configured to cause the network node to:
configure multiple discontinuous reception (DRX) configurations for a user equipment (UE), wherein the multiple DRX configurations include:
more than two DRX configurations for the UE as an individual UE, or
at least a first DRX configuration for the UE as the individual UE and at least a second DRX configuration for a collaborative UE group; and
provide a control signal for the UE based on the multiple DRX configurations.

15. The apparatus of claim 14, wherein each DRX configuration of the multiple DRX configurations has a corresponding radio network temporary identifier (RNTI).

16. The apparatus of claim 14, wherein the one or more processors are further configured to cause the network node to:
provide a wake up signal (WUS) that indicates a cause for the UE to wake up, wherein the cause is associated with a DRX configuration of the multiple DRX configurations, and wherein the cause is indicated by one or more of:
a radio network temporary identifier (RNTI) for the WUS,
a resource for the WUS, or
information in a payload of the WUS.

17. The apparatus of claim 16, wherein the one or more processors are further configured to cause the network node to:
receive wake up time information for each UE in the collaborative UE group, wherein a wake up time for the collaborative UE group is based on a shortest wake up time supported by UEs in the collaborative UE group or a longest wake up time supported by at least one UE in the collaborative UE group.

18. The apparatus of claim 14, wherein the one or more processors are further configured to cause the network node to:
receive a request for a wake up time offset for the UE, wherein the wake up time offset aligns wake up times for the multiple DRX configurations.

19. The apparatus of claim 14, wherein the one or more processors are further configured to cause the network node to:
provide a wake up signal for a second UE in the collaborative UE group within a monitoring occasion for a first UE in the collaborative UE group.

20. An apparatus for wireless communication at a user equipment (UE), comprising:
one or more memories; and
one or more processors coupled to the one or more memories and configured to cause the UE to:
receive multiple discontinuous reception (DRX) configurations; and
receive a wake up signal (WUS) that indicates a cause for the UE to wake up, wherein the cause is associated with a DRX configuration of the multiple DRX configurations.
